(19) United States
(12) Patent Application Publication
(10) Pub. No.: US 2003/0161628 A1
(43) Pub. Date: Aug. 28, 2003

(54) Image processing method, image processing apparatus, image recording apparatus and recording medium

(76) Inventors: Tsukasa Ito, Tokyo (JP); Hiroaki Takano, Tokyo (JP)

Correspondence Address: CANTOR COLBURN, LLP, 55 GRIFFIN ROAD SOUTH, BLOOMFIELD, CT, 06002

(21) Appl. No.: 10/367,066

(22) Filed: Feb. 14, 2003

(30) Foreign Application Priority Data
Feb. 22, 2002 (JP) JP2002-046940

(51) Int. Cl. G03D 3/00

(52) U.S. Cl. 396/564

(57) ABSTRACT

A method of applying an image processing onto two dimensionally-arranged image data representing a photographed image including a main photographed-subject and producing image signals to reproduce the photographed image visually with one of various reproduction sizes on one of various kinds of recording media, includes a reproduction size determining step of determining a reproduction size of the photographed image to be reproduced visually on a recording medium; a subject size determining step of determining a size of the main photographed-subject on the determined reproduction size of the photographed image; an image processing content changing step of changing a content of the image processing on the basis of the determined reproduction size of the photographed image and the determined size of the main photographed-subject; and a processing step of applying the image processing with the changed content onto the two dimensionally-arranged image data and producing image signals.

### BACKGROUND OF THE INVENTION

The present invention relates to an image processing method for an exposed image, a recording medium on which a program for executing the image processing method is recorded, an image processing apparatus and an image recording apparatus.

When outputting image signals which display photographed image on a medium, there is conducted prescribed image processing on the image signals which display the inputted exposed image, so that preferable impression may be given when an image outputted on the medium is observed.

In TOKKAIHEI No. 11-339035, there is disclosed a method to determine simply an image processing parameter for emphasizing or controlling a face image in accordance with a size of a face image included in an image.

In TOKKAIHEI No. 11-196364, there is disclosed a technology which prevents unpleasant frequency component from being enhanced when digital image data whose granulated sharpness is optimized in accordance with a prescribed output size are enlarged or reduced for reproduction.

In TOKKAIHEI No. 9-233423, there is disclosed an image data converting method for a digital printer that records images on a recording material based on image data wherein a face image of a person is extracted from image data, and an image processing method is changed depending on a size of an area of this face image or on the presence or absence of the face image area.

However, in recent years, a generating means for image signals indicating a photographed image is diversified into an inexpensive digital camera for a toy, a lens-shutter digital camera, a high-grade digital camera of an SRL type, a film scanner and a flat-bed scanner. Further, a method to output image signals on a medium is diversified into a silver halide digital printer, an ink-jet printer, a thermal printer, a sublimation printer, and an electrophotographic printer, and thereby, images outputted from aforementioned printers are diversified in terms of sizes from a seal of several centimeters square to a poster-like one. In addition, image signals indicating a photographed image through the Internet have come to circulate, and there are increasing occasions wherein image signals are outputted in a size of a medium which was not intended by a photographer. In the complicated circumstance as this, it has become difficult for conventional technologies to output images which make a favorable impression.

The technology disclosed in TOKKAIHEI No. 11-339035 is an image processing parameter determining method in the case of conducting image processing for image data indicating an image including a face image of a person wherein a size of the face image is estimated based on the position specified in the lateral direction of the face image in the image displayed by a display means as a visible image, and the image processing parameter is determined based on the estimated size of the face image, and the position specified in the lateral direction of the face image is obtained when an operator specifies the position in the lateral direction of the face image by the use of an inputting means such as, for example, a mouse. This technology is on the assumption that a position in the lateral direction of a face image is specified by an operator, and it cannot be used in the general printing environment because it is time-consuming. In addition, this technology has no consideration about the subject to give a favorable impression for all of the various print sizes.

The technology disclosed in TOKKAIHEI No. 11-196264 is on the assumption that digital original image data have been subjected to the processing to enhance a high frequency component so that the granulated sharpness may be optimum for the prescribed output size determined in advance. However, the aforementioned assumption is not always satisfied in the printing environment where image data obtained by various photographing means are intermingled. In addition, this technology does not give the condition to make the granulated sharpness to be optimum in the specific output size. Further, the technology has no consideration for the occupying size of a main photographed-subject in the image.

The technology disclosed in TOKKAIHEI No. 9-233423 is characterized in that an occupying rate of a face area in an image is acquired, and when the occupying rate of the face image area grows smaller, the degree of edge enhancement is made to be greater gradually, and gradation is made to be harder gradually. In this technology, however, the factor for determining the degree of image processing is only the occupying rate of a face area in an image, and there is no consideration about important factors such as a difference of a size that appears when an image is printed on a medium and a change of the observation distance caused by the above-mentioned difference of a size.

### SUMMARY OF THE INVENTION

In view of the aforementioned circumstances, an object of the invention is to provide an image processing method for generating image signals giving preferable output by conducting prescribed image processing on image signals indicating a photographed image, based on a simple and all-purpose means, when outputting image signals in various sizes on various media, under the condition that image signals indicating a photographed image based on various photographing means are intermingled, a recording medium on which a program to execute the image processing method is recorded, an image processing apparatus and an image recording apparatus that conducts a prescribed image processing on image signals indicating a photographed image and gives preferable output.

The object can be attained by the following method, readable product and apparatus.

In a method of applying an image processing onto two dimensionally-arranged image data representing a photographed image including a main photographed-subject and producing image signals to reproduce the photographed image visually with one of various reproduction sizes on one of various kinds of recording media, the method comprises:

a reproduction size determining step of determining a reproduction size of the photographed image to be reproduced visually on a recording medium;

a subject size determining step of determining a size of the main photographed-subject on the determined reproduction size of the photographed image;

an image processing content changing step of changing a content of the image processing on the basis of the determined reproduction size of the photographed image and the determined size of the main photographed-subject; and

a processing step of applying the image processing with the changed content onto the two dimensionally-arranged image data and producing image signals to reproduce the photographed image visually with the determined reproduction size on the recording medium.

In a readable product from which a program representing an image processing method is read, the image processing method is a method of applying an image processing onto two dimensionally-arranged image data representing a photographed image including a main photographed-subject and producing image signals to reproduce the photographed image visually with one of various reproduction sizes on one of various kinds of recording media, the method comprises:

a reproduction size determining step of determining a reproduction size of the photographed image to be reproduced visually on a recording medium;

a subject size determining step of determining a size of the main photographed-subject on the determined reproduction size of the photographed image;

an image processing content changing step of changing a content of the image processing on the basis of the determined reproduction size of the photographed image and the determined size of the main photographed-subject; and

a processing step of applying the image processing with the changed content onto the two dimensionally-arranged image data and producing image signals to reproduce the photographed image visually with the determined reproduction size on the recording medium.

In an apparatus for applying an image processing onto two dimensionally-arranged image data representing a photographed image including a main photographed-subject and producing image signals to reproduce the photographed image visually with one of various reproduction sizes on one of various kinds of recording media, the apparatus comprises:

a reproduction size determining section for determining a reproduction size of the photographed image to be reproduced visually on a recording medium;

a subject size determining section for determining a size of the main photographed-subject on the determined reproduction size of the photographed image;

an image processing content changing section for changing a content of the image processing on the basis of the determined reproduction size of the photographed image and the determined size of the main photographed-subject; and

a processing section for applying the image processing with the changed content onto the two dimensionally-arranged image data and producing image signals to reproduce the photographed image visually with the determined reproduction size on the recording medium.

Further, the image processing method of the present invention may be obtained with the following items as preferable examples.

The invention described in Item 1 is represented by an image processing method that conducts a prescribed image processing on image signals indicating a photographed image and thereby generates image signals for output, wherein there is included a processing content determining step that determines contents of the image processing based on an angle of field of a main photographed-subject that is positioned at a viewing distance for the outputted image.

The invention described in Item 2 is represented by an image processing method that conducts a prescribed image processing on image signals indicating a photographed image and thereby generates image signals for output, wherein there are included a size information acquiring step that acquires a size of an output image and a size of a main photographed-subject in the output image, and a processing content determining step that determines contents of the image processing based on the size of the output image and the size of the main photographed-subject in the output image acquired in the size information acquiring step.

The invention described in Item 3 is represented by an image processing method that conducts a prescribed image processing on image signals indicating a photographed image and thereby generates image signals for output, wherein there are included a size information acquiring step that acquires a size of an output image, a size estimating step that estimates a size of a main photographed-subject in the output image, based on a size of the output image acquired in the size information acquiring step and a processing content determining step that determines contents of the image processing based on a size of a main photographed-subject in the output image estimated in the size estimating step.

The invention described in Item 4 is represented by an image processing method that conducts a prescribed image processing on image signals indicating a photographed image and thereby generates image signals for output, wherein there are included a rate information acquiring step that acquires an occupying rate of a main photographed-subject in the image, a size information acquiring step that acquires a size of an output image, a size estimating step that estimates a size of the main photographed-subject in the output image based on the occupying rate of the main photographed-subject acquired in the rate information acquiring step and the size of the output image acquired in the size information acquiring step and a processing content determining step that determines contents of the image processing based on the size of the main photographed-subject in the output image estimated in the size estimating step.

The invention described in Item 5 is represented by an image processing method that conducts a prescribed image processing on image signals indicating a photographed image and thereby generates image signals for output, wherein there are included a condition information acquiring step that acquires information about photographing conditions, a rate estimating step that estimates an occupying rate of a main photographed-subject from information about the photographing conditions acquired in the condition information acquiring step, a size information acquiring step that acquires a size of an output image, a size estimating step that estimates a size of a main photographed-subject in the output image, based on information showing the occupying rate of the main photographed-subject estimated in the rate estimating step and a size of the output image acquired in the size information acquiring step and a processing content determining step that determines contents of the image processing based on a size of a main photographed-subject in the output image estimated in the size estimating step.

The invention described in Item 6 is represented by an image processing method that conducts a prescribed image processing on image signals indicating a photographed image and thereby generates image signals for output, wherein there are included a condition information acquiring step that acquires information about at least one photographing condition among a subject area, a photographing scene type, a subject distance and a detection of reflected light of electronic flash, a rate estimating step that estimates an occupying rate of a main photographed-subject from information acquired in the condition information acquiring step, a size information acquiring step that acquires a size of an output image, a size estimating step that estimates a size of a main photographed-subject in the output image, based on information showing the occupying rate of the main photographed-subject estimated in the rate estimating step and a size of the output image acquired in the size information acquiring step and a processing content determining step that determines contents of the image processing based on a size of a main photographed-subject in the output image estimated in the size estimating step.

The invention described in Item 7 is the image processing method described in either one of Items 5 and 6, wherein in the condition information acquiring step, information about the photographing condition is acquired from tag information added to image signals indicating a photographed image.

The invention described in Item 8 is represented by an image processing method that conducts a prescribed image processing on image signals indicating a photographed image and thereby generates image signals for output, wherein there are included a rate information acquiring step that acquires an occupying rate of a main photographed-subject in the image, a first size estimating step that estimates a size of an output image, a second size estimating step that estimates a size of the main photographed-subject in the output image based on the occupying rate of the main photographed-subject acquired in the rate information acquiring step and the size of the output image estimated in the first size estimating step and a processing content determining step that determines contents of the image processing based on the size of the main photographed-subject in the output image estimated in the second size estimating step.

The invention described in Item 9 is represented by an image processing method that conducts a prescribed image processing on image signals indicating a photographed image and thereby generates image signals for output, wherein there are included a condition information acquiring step that acquires information about photographing conditions, a rate estimating step that estimates an occupying rate of a main photographed-subject from information about the photographing conditions acquired in the condition information acquiring step, a first size estimating step that estimates a size of an output image, a second size estimating step that estimates a size of the main photographed-subject in the output image based on the occupying rate of the main photographed-subject estimated in the rate estimating step and the size of the output image estimated in the first size estimating step and a processing content determining step that determines contents of the image processing based on the size of the main photographed-subject in the output image estimated in the second size estimating step.

The invention described in Item 10 is represented by an image processing method that conducts a prescribed image processing on image signals indicating a photographed image and thereby generates image signals for output, wherein there are included a condition information acquiring step that acquires information about at least one photographing condition among a subject area, a photographing scene type, a subject distance and a detection of reflected light of electronic flash, a rate estimating step that estimates an occupying rate of a main photographed-subject from information regarding the photographing condition acquired in the condition information acquiring step, a first size estimating step that estimates a size of an output image from the information regarding the photographing condition acquired in the condition information acquiring step, a second size estimating step that estimates a size of the main photographed-subject in the output image based on the occupying rate of the main photographed-subject estimated in the rate estimating step and the size of the output image estimated in the first size estimating step and a processing content determining step that determines contents of the image processing based on the size of the main photographed-subject in the output image estimated in the second size estimating step.

The invention described in Item 11 is the image processing method described in either one of Items 9 and 10, wherein in the condition information acquiring step, information about the photographing condition is acquired from tag information added to image signals indicating a photographed image.

The invention described in Item 13 is represented by an image processing method that conducts a prescribed image processing on image signals indicating a photographed image and thereby generates image signals for output, wherein there is included a processing content changing step that changes contents of the image processing based on an angle of field of a main photographed-subject that is positioned at a viewing distance for the outputted image.

The invention described in Item 13 is represented by an image processing method that conducts a prescribed image processing on image signals indicating a photographed image and thereby generates image signals for output, wherein there are included a size information acquiring step that acquires a size of an output image and a size of a main photographed-subject in the output image, and a processing content changing step that changes contents of the image processing based on the size of the output image and the size of the main photographed-subject in the output image acquired in the size information acquiring step.

The invention described in Item 14 is represented by an image processing method that conducts a prescribed image processing on image signals indicating a photographed image and thereby generates image signals for output, wherein there are included a size information acquiring step that acquires a size of an output image, a size estimating step that estimates a size of a main photographed-subject in the output image, based on a size of the output image acquired in the size information acquiring step and a processing content changing step that changes contents of the image processing based on a size of a main photographed-subject in the output image estimated in the size estimating step.

The invention described in Item 15 is represented by an image processing method that conducts a prescribed image processing on image signals indicating a photographed image and thereby generates image signals for output, wherein there are included a rate information acquiring step that acquires an occupying rate of a main photographed-subject in the image, a size information acquiring step that acquires a size of an output image, a size estimating step that estimates a size of the main photographed-subject in the output image based on the occupying rate of the main photographed-subject acquired in the rate information acquiring step and the size of the output image acquired in the size information acquiring step and a processing content changing step that changes contents of the image processing based on the size of the main photographed-subject in the output image estimated in the size estimating step.

The invention described in Item 16 is represented by an image processing method that conducts a prescribed image processing on image signals indicating a photographed image and thereby generates image signals for output, wherein there are included a condition information acquiring step that acquires information about photographing conditions, a rate estimating step that estimates an occupying rate of a main photographed-subject from information about the photographing conditions acquired in the condition information acquiring step, a size information acquiring step that acquires a size of an output image, a size estimating step that estimates a size of a main photographed-subject in the output image, based on information showing the occupying rate of the main photographed-subject estimated in the rate estimating step and a size of the output image acquired in the size information acquiring step and processing content changing step that changes contents of the image processing based on a size of a main photographed-subject in the output image estimated in the size estimating step.

The invention described in Item 17 is represented by an image processing method that conducts a prescribed image processing on image signals indicating a photographed image and thereby generates image signals for output, wherein there are included a condition information acquiring step that acquires information about at least one photographing condition among a subject area, a photographing scene type, a subject distance and a detection of reflected light of electronic flash, a rate estimating step that estimates an occupying rate of a main photographed-subject from information acquired in the condition information acquiring step, a size information acquiring step that acquires a size of an output image, a size estimating step that estimates a size of a main photographed-subject in the output image, based on information showing the occupying rate of the main photographed-subject estimated in the rate estimating step and a size of the output image acquired in the size information acquiring step and processing content changing step that changes contents of the image processing based on a size of a main photographed-subject in the output image estimated in the size estimating step.

The invention described in Item 18 is the image processing method described in either one of Items 16 and 17, wherein in the condition information acquiring step, information about the photographing condition is acquired from tag information added to image signals indicating a photographed image.

The invention described in Item 19 is represented by an image processing method that conducts a prescribed image processing on image signals indicating a photographed image and thereby generates image signals for output, wherein there are included a rate information acquiring step that acquires an occupying rate of a main photographed-subject in the image, a first size estimating step that estimates a size of an output image, a second size estimating step that estimates a size of the main photographed-subject in the output image based on the occupying rate of the main photographed-subject acquired in the rate information acquiring step and the size of the output image estimated in the first size estimating step and processing content changing step that changes contents of the image processing based on the size of the main photographed-subject in the output image estimated in the second size estimating step.

The invention described in Item 20 is represented by an image processing method that conducts a prescribed image processing on image signals indicating a photographed image and thereby generates image signals for output, wherein there are included a condition information acquiring step that acquires information about photographing conditions, a rate estimating step that estimates an occupying rate of a main photographed-subject from information about the photographing conditions acquired in the condition information acquiring step, a first size estimating step that estimates a size of an output image, a second size estimating step that estimates a size of the main photographed-subject in the output image based on the occupying rate of the main photographed-subject estimated in the rate estimating step and the size of the output image estimated in the first size estimating step and processing content changing step that changes contents of the image processing based on the size of the main photographed-subject in the output image estimated in the second size estimating step.

The invention described in Item 21 is represented by an image processing method that conducts a prescribed image processing on image signals indicating a photographed image and thereby generates image signals for output, wherein there are included a condition information acquiring step that acquires information about at least one photographing condition among a subject area, a photographing scene type, a subject distance and a detection of reflected light of electronic flash, a rate estimating step that estimates an occupying rate of a main photographed-subject from information regarding the photographing condition acquired in the condition information acquiring step, a first size estimating step that estimates a size of an output image from the information regarding the photographing condition acquired in the condition information acquiring step, a second size estimating step that estimates a size of the main photographed-subject in the output image based on the occupying rate of the main photographed-subject estimated in the rate estimating step and the size of the output image estimated in the first size estimating step and processing content changing step that changes contents of the image processing based on the size of the main photographed-subject in the output image estimated in the second size estimating step.

The invention described in Item 22 is the image processing method described in either one of Items 20 and 21, wherein in the condition information acquiring step, information about the photographing condition is acquired from tag information added to image signals indicating a photographed image.

The invention described in Item 23 is the image processing method described in either one of Items 1-22, wherein there are further included a processing tendency acquiring step that acquires a tendency of image processing conducted when image signals indicating a photographed image are generated, and a correction step that corrects a level of image processing based on information showing the tendency of the image processing acquired in the processing tendency acquiring step.

The invention described in Item 24 is the image processing method described in either one of Items 1-22, wherein there are further included a processing tendency acquiring step that acquires at least one image processing tendency among contrast processing, sharpness processing, graininess processing and chroma processing, and a correction step that corrects a level of the image processing based on information showing the tendency of the image processing acquired in the processing tendency acquiring step.

The invention described in Item 25 is the image processing method described in either one of Items 23 and 24, wherein the correction step corrects, based on the tendency of image processing conducted when image signals indicating a photographed image are generated, in the form wherein overlapping and reciprocity between the contents of correction about the level of the image processing and the image processing conducted in the course of photographing are taken into consideration.

The invention described in Item 26 is the image processing method described in either one of Items 23-25, wherein the processing tendency acquiring step acquires a tendency of the image processing conducted when image signals indicating a photographed image are generated, from tag information added to the image signals indicating the photographed image.

The invention described in Item 27 is the image processing method described in either one of Items 1-26, wherein there are further included a preference tendency acquiring step that acquires a preference tendency of a user and a processing level setting step that establishes a level of the image processing based on information showing the user's preference tendency acquired in the preference tendency acquiring step.

The invention described in Item 28 is the image processing method described in either one of Items 1-26, wherein there are further included a preference tendency estimating step that estimates a preference tendency of user and a processing level setting step that establishes a level of the image processing based on information showing the user's preference tendency estimated in the preference tendency estimating step.

The invention described in Item 29 is the image processing method described in either one of Items 1-26, wherein there are further included an establishment information acquiring step that acquires at least one piece of information about setting of a model of photographing apparatus, the number of pixels for photographing, exposure mode and white balance, a preference tendency estimating step that estimates a user's preference tendency from the information acquired in the establishment information acquiring step and a processing level setting step that establishes a level of the image processing based on information showing the user's preference tendency estimated in the preference tendency estimating step.

The invention described in Item 30 is the image processing method described in either one of Items 1-26, wherein there are further included a preference tendency acquiring step that acquires a preference tendency of a user and a processing level revising step that revises a level of the image processing based on information showing the user's preference tendency acquired in the preference tendency acquiring step.

The invention described in Item 31 is the image processing method described in either one of Items 1-26, wherein there are further included a preference tendency estimating step that estimates a preference tendency of user (the tendency of user's taste) and a processing level revising step that revises a level of the image processing based on information showing the user's preference tendency estimated in the preference tendency estimating step.

The invention described in Item 32 is the image processing method described in either one of Items 1-26, wherein there are further included an establishment information acquiring step that acquires at least one piece of information about setting of a model of photographing apparatus, the number of pixels for photographing, exposure mode and white balance, a preference tendency estimating step that estimates a user's preference tendency from the information acquired in the establishment information acquiring step and a processing level revising step that revises a level of the image processing based on information showing the user's preference tendency estimated in the preference tendency estimating step.

The invention described in Item 33 is the image processing method described in either one of Items 27-32, wherein there is further included a preference judging information acquiring step that acquires preference judging information used for acquiring or estimating a user's preference from tag information added to the image signals indicating the photographed image.

The invention described in Item 34 is the image processing method described in either one of Items 1-33, wherein there are further included an field angle estimating step that estimates an angle of field by which a main photographed-subject is covered when an image is observed and a content changing step that changes contents of the image processing according to the angle of field estimated in the field angle estimating step.

The invention described in Item 35 is the image processing method described in Item 34, wherein there is further included a content changing step that changes contents of the image processing depending on whether the angle of field estimated in the field angle estimating step can be covered by 100 or not.

The invention described in Item 36 is the image processing method described in Item 34, wherein there is further included a contrast-increasing step that increases contrast more for the smaller angle of field, when the angle of field estimated in the field angle estimating step is smaller than 100.

The invention described in Item 37 is the image processing method described in Item 34, wherein there is further included a step to increase contrast by 5% or more that increases contrast 5% or more when the angle of field estimated in the field angle estimating step is smaller than 100.

The invention described in Item 38 is the image processing method described in Item 34, wherein there is further included a contrast-reduction step that reduces contrast more for the greater angle of field, when the angle of field estimated in the field angle estimating step is greater than 10°.

The invention described in Item 39 is the image processing method described in Item 34, wherein there is further included a step to decrease contrast by 5% or more that decreases contrast 5% or more when the angle of field estimated in the field angle estimating step is greater than 100.

The invention described in Item 40 is the image processing method described in Item 34, wherein there is further included an enhancement processing step that conducts edge enhancement or high-frequency component enhancement processing more for the smaller angle of field, when the angle of field estimated in the field angle estimating step is smaller than 100.

The invention described in Item 41 is the image processing method described in Item 34, wherein there is further included an inhibition processing step that conducts removal of granulated noise or medium frequency component inhibition processing more for the greater angle of field, when the angle of field estimated in the field angle estimating step is greater than 100.

The invention described in Item 42 is the image processing method described in Item 34, wherein there is further included a chroma enhancement step that enhances chroma more for the smaller angle of field when the angle of field estimated in the field angle estimating step is smaller than 100.

The invention described in Item 43 is the image processing method described in Item 34, wherein there is further included a chroma enhancement step that enhances chroma more for the greater angle of field when the angle of field estimated in the field angle estimating step is greater than 100.

The image processing apparatus of the present invention can be obtained with the following items.

The invention described in Item 45 is represented by an image processing apparatus that conducts a prescribed image processing on image signals indicating a photographed image and thereby generates image signals for output, wherein there is included a processing content determining means that determines contents of the image processing based on an angle of field of a main photographed-subject that is positioned at a viewing distance for the outputted image.

The invention described in Item 46 is represented by an image processing apparatus that conducts a prescribed image processing on image signals indicating a photographed image and thereby generates image signals for output, wherein there are included a size information acquiring means that acquires a size of an output image and a size of a main photographed-subject in the output image, and a processing content determining means that determines contents of the image processing based on the size of the output image and the size of the main photographed-subject in the output image acquired in the size information acquiring means.

The invention described in Item 47 is represented by an image processing apparatus that conducts a prescribed image processing on image signals indicating a photographed image and thereby generates image signals for output, wherein there are included a size information acquiring means that acquires a size of an output image, a size estimating means that estimates a size of a main photographed-subject in the output image, based on a size of the output image acquired in the size information acquiring means and a processing content determining means that determines contents of the image processing based on a size of a main photographed-subject in the output image estimated in the size estimating means.

The invention described in Item 48 is represented by an image processing apparatus that conducts a prescribed image processing on image signals indicating a photographed image and thereby generates image signals for output, wherein there are included a rate information acquiring means that acquires an occupying rate of a main photographed-subject in the image, a size information acquiring means that acquires a size of an output image, a size estimating means that estimates a size of the main photographed-subject in the output image based on the occupying rate of the main photographed-subject acquired in the rate information acquiring means and the size of the output image acquired in the size information acquiring means and a processing content determining means that determines contents of the image processing based on the size of the main photographed-subject in the output image estimated in the size estimating means.

The invention described in Item 49 is represented by an image processing apparatus that conducts a prescribed image processing on image signals indicating a photographed image and thereby generates image signals for output, wherein there are included a condition information acquiring means that acquires information about photographing conditions, a rate estimating means that estimates an occupying rate of a main photographed-subject from information about the photographing conditions acquired in the condition information acquiring means, a size information acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and a processing content determining means that determines contents of the image processing based on a size of a main photographed-subject in the output image estimated in the size estimating means.

The invention described in Item 50 is represented by an image processing apparatus that conducts a prescribed image processing on image signals indicating a photographed image and thereby generates image signals for output, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information acquired in the condition information acquiring means, a size information acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and a processing content determining means that determines contents of the image processing based on a size of a main photographed-subject in the output image estimated in the size estimating means.

The invention described in Item 51 is the image processing apparatus described in either one of Items 49 and 50, wherein in the condition information acquiring means, information about the photographing condition is acquired from tag information added to image signals indicating a photographed image.

The invention described in Item 52 is represented by an image processing apparatus that conducts a prescribed image processing on image signals indicating a photographed image and thereby generates image signals for output, wherein there are included a rate information acquiring means that acquires an occupying rate of a main photographed-subject in the image, a first size estimating means that estimates a size of an output image, a second size estimating means that estimates a size of the main photographed-subject in the output image based on the occupying rate of the main photographed-subject acquired in the rate information acquiring means and the size of the output image estimated in the first size estimating means and a processing content determining means that determines contents of the image processing based on the size of the main photographed-subject in the output image estimated in the second size estimating means.

The invention described in Item 53 is represented by an image processing apparatus that conducts a prescribed image processing on image signals indicating a photographed image and thereby generates image signals for output, wherein there are included a condition information acquiring means that acquires information about photographing conditions, a rate estimating means that estimates an occupying rate of a main photographed-subject from information about the photographing conditions acquired in the condition information acquiring means, a first size estimating means that estimates a size of an output image, a second size estimating means that estimates a size of the main photographed-subject in the output image based on the occupying rate of the main photographed-subject estimated in the rate estimating means and the size of the output image estimated in the first size estimating means and a processing content determining means that determines contents of the image processing based on the size of the main photographed-subject in the output image estimated in the second size estimating means.

The invention described in Item 54 is represented by an image processing apparatus that conducts a prescribed image processing on image signals indicating a photographed image and thereby generates image signals for output, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information regarding the photographing condition acquired in the condition information acquiring means, a first size estimating means that estimates a size of an output image from the information regarding the photographing condition acquired in the condition information acquiring means, a second size estimating means that estimates a size of the main photographed-subject in the output image based on the occupying rate of the main photographed-subject estimated in the rate estimating means and the size of the output image estimated in the first size estimating means and a processing content determining means that determines contents of the image processing based on the size of the main photographed-subject in the output image estimated in the second size estimating means.

The invention described in Item 55 is the image processing apparatus described in either one of Items 53 and 54, wherein in the condition information acquiring means, information about the photographing condition is acquired from tag information added to image signals indicating a photographed image.

The invention described in Item 56 is represented by an image processing apparatus that conducts a prescribed image processing on image signals indicating a photographed image and thereby generates image signals for output, wherein there is included a processing content changing means that changes contents of the image processing based on an angle of field of a main photographed-subject that is positioned at a viewing distance for the outputted image.

The invention described in Item 57 is represented by an image processing apparatus that conducts a prescribed image processing on image signals indicating a photographed image and thereby generates image signals for output, wherein there are included a size information acquiring means that acquires a size of an output image and a size of a main photographed-subject in the output image, and a processing content changing means that changes contents of the image processing based on the size of the output image and the size of the main photographed-subject in the output image acquired in the size information acquiring means.

The invention described in Item 58 is represented by an image processing apparatus that conducts a prescribed image processing on image signals indicating a photographed image and thereby generates image signals for output, wherein there are included a size information acquiring means that acquires a size of an output image, a size estimating means that estimates a size of a main photographed-subject in the output image, based on a size of the output image acquired in the size information acquiring means and a processing content changing means that changes contents of the image processing based on a size of a main photographed-subject in the output image estimated in the size estimating means.

The invention described in Item 59 is represented by an image processing apparatus that conducts a prescribed image processing on image signals indicating a photographed image and thereby generates image signals for output, wherein there are included a rate information acquiring means that acquires an occupying rate of a main photographed-subject in the image, a size information acquiring means that acquires a size of an output image, a size estimating means that estimates a size of the main photographed-subject in the output image based on the occupying rate of the main photographed-subject acquired in the rate information acquiring means and the size of the output image acquired in the size information acquiring means and a processing content changing means that changes contents of the image processing based on the size of the main photographed-subject in the output image estimated in the size estimating means.

The invention described in Item 60 is represented by an image processing apparatus that conducts a prescribed image processing on image signals indicating a photographed image and thereby generates image signals for output, wherein there are included a condition information acquiring means that acquires information about photographing conditions, a rate estimating means that estimates an occupying rate of a main photographed-subject from information about the photographing conditions acquired in the condition information acquiring means, a size information acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and processing content changing means that changes contents of the image processing based on a size of a main photographed-subject in the output image estimated in the size estimating means.

The invention described in Item 61 is represented by an image processing apparatus that conducts a prescribed image processing on image signals indicating a photographed image and thereby generates image signals for output, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information acquired in the condition information acquiring means, a size information acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and processing content changing means that changes contents of the image processing based on a size of a main photographed-subject in the output image estimated in the size estimating means.

The invention described in Item 62 is the image processing apparatus described in either one of Items 60 and 61, wherein in the condition information acquiring means, information about the photographing condition is acquired from tag information added to image signals indicating a photographed image.

The invention described in Item 63 is represented by an image processing apparatus that conducts a prescribed image processing on image signals indicating a photographed image and thereby generates image signals for output, wherein there are included a rate information acquiring means that acquires an occupying rate of a main photographed-subject in the image, a first size estimating means that estimates a size of an output image, a second size estimating means that estimates a size of the main photographed-subject in the output image based on the occupying rate of the main photographed-subject acquired in the rate information acquiring means and the size of the output image estimated in the first size estimating means and processing content changing means that changes contents of the image processing based on the size of the main photographed-subject in the output image estimated in the second size estimating means.

The invention described in Item 64 is represented by an image processing apparatus that conducts a prescribed image processing on image signals indicating a photographed image and thereby generates image signals for output, wherein there are included a condition information acquiring means that acquires information about photographing conditions, a rate estimating means that estimates an occupying rate of a main photographed-subject from information about the photographing conditions acquired in the condition information acquiring means, a first size estimating means that estimates a size of an output image, a second size estimating means that estimates a size of the main photographed-subject in the output image based on the occupying rate of the main photographed-subject estimated in the rate estimating means and the size of the output image estimated in the first size estimating means and processing content changing means that changes contents of the image processing based on the size of the main photographed-subject in the output image estimated in the second size estimating means.

The invention described in Item 65 is represented by an image processing apparatus that conducts a prescribed image processing on image signals indicating a photographed image and thereby generates image signals for output, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information regarding the photographing condition acquired in the condition information acquiring means, a first size estimating means that estimates a size of an output image from the information regarding the photographing condition acquired in the condition information acquiring means, a second size estimating means that estimates a size of the main photographed-subject in the output image based on the occupying rate of the main photographed-subject estimated in the rate estimating means and the size of the output image estimated in the first size estimating means and processing content changing means that changes contents of the image processing based on the size of the main photographed-subject in the output image estimated in the second size estimating means.

The invention described in Item 66 is the image processing apparatus described in either one of Items 64 and 65, wherein in the condition information acquiring means, information about the photographing condition is acquired from tag information added to image signals indicating a photographed image.

The invention described in Item 67 is the image processing apparatus described in either one of Items 45-66, wherein there are further included a processing tendency acquiring means that acquires a tendency of image processing conducted when image signals indicating a photographed image are generated, and a correction means that corrects a level of image processing based on information showing the tendency of the image processing acquired in the processing tendency acquiring means.

The invention described in Item 68 is the image processing apparatus described in either one of Items 45-66, wherein there are further included a processing tendency acquiring means that acquires at least one image processing tendency among contrast processing, sharpness processing, graininess processing and chroma processing, and a correction means that corrects a level of the image processing based on information showing the tendency of the image processing acquired in the processing tendency acquiring means.

The invention described in Item 69 is the image processing apparatus described in either one of Items 67 and 68, wherein the correction means corrects, based on the tendency of image processing conducted when image signals indicating a photographed image are generated, in the form wherein overlapping and reciprocity between the contents of correction about the level of the image processing and the image processing conducted in the course of photographing are taken into consideration.

The invention described in Item 70 is the image processing apparatus described in either one of Items 67-69, wherein the processing tendency acquiring means acquires a tendency of the image processing conducted when image signals indicating a photographed image are generated, from tag information added to the image signals indicating the photographed image.

The invention described in Item 71 is the image processing apparatus described in either one of Items 45-70, wherein there are further included a preference tendency acquiring means that acquires a preference tendency of a user and a processing level setting means that establishes a level of the image processing based on information showing the user's preference tendency acquired in the preference tendency acquiring means.

The invention described in Item 72 is the image processing apparatus described in either one of Items 45-70, wherein there are further included a preference tendency estimating means that estimates a preference tendency of user and a processing level setting means that establishes a level of the image processing based on information showing the user's preference tendency estimated in the preference tendency estimating means.

The invention described in Item 73 is the image processing apparatus described in either one of Items 45-70, wherein there are further included an establishment information acquiring means that acquires at least one piece of information about setting of a model of photographing apparatus, the number of pixels for photographing, exposure mode and white balance, a preference tendency estimating means that estimates a user's preference tendency from the information acquired in the establishment information acquiring means and a processing level setting means that establishes a level of the image processing based on information showing the user's preference tendency estimated in the preference tendency estimating means.

The invention described in Item 74 is the image processing apparatus described in either one of Items 45-70, wherein there are further included a preference tendency acquiring means that acquires a preference tendency of a user and a processing level revising means that revises a level of the image processing based on information showing the user's preference tendency acquired in the preference tendency acquiring means.

The invention described in Item 75 is the image processing apparatus described in either one of Items 45-70, wherein there are further included a preference tendency estimating means that estimates a preference tendency of user and a processing level revising means that revises a level of the image processing based on information showing the user's preference tendency estimated in the preference tendency estimating means.

The invention described in Item 76 is the image processing apparatus described in either one of Items 45-70, wherein there are further included an establishment information acquiring means that acquires at least one piece of information about setting of a model of photographing apparatus, the number of pixels for photographing, exposure mode and white balance, a preference tendency estimating means that estimates a user's preference tendency from the information acquired in the establishment information acquiring means and a processing level revising means that revises a level of the image processing based on information showing the user's preference tendency estimated in the preference tendency estimating means.

The invention described in Item 77 is the image processing apparatus described in either one of Items 71-76, wherein there is further included a preference judging information acquiring means that acquires preference judging information used for acquiring or estimating a user's preference from tag information added to the image signals indicating the photographed image.

The invention described in Item 78 is the image processing apparatus described in either one of Items 45-77, wherein there are further included an field angle estimating means that estimates an angle of field by which a main photographed-subject is covered when an image is observed and a content changing means that changes contents of the image processing according to the angle of field estimated in the field angle estimating means.

The invention described in Item 79 is the image processing apparatus described in Item 78, wherein there is further included a content changing means that changes contents of the image processing depending on whether the angle of field estimated in the field angle estimating means can be covered by 10° or not.

The invention described in Item 80 is the image processing apparatus described in Item 78, wherein there is further included a contrast-increasing means that increases contrast more for the smaller angle of field, when the angle of field estimated in the field angle estimating means is smaller than 10°.

The invention described in Item 81 is the image processing apparatus described in Item 78, wherein there is further included a means to increase contrast by 5% or more that increases contrast 5% or more when the angle of field estimated in the field angle estimating means is smaller than 10°.

The invention described in Item 82 is the image processing apparatus described in Item 78, wherein there is further included a contrast-reduction means that reduces contrast more for the greater angle of field, when the angle of field estimated in the field angle estimating means is greater than 10°.

The invention described in Item 83 is the image processing apparatus described in Item 78, wherein there is further included a means to decrease contrast by 5% or more that decreases contrast 5% or more when the angle of field estimated in the field angle estimating means is greater than 10°.

The invention described in Item 84 is the image processing apparatus described in Item 78, wherein there is further included an enhancement processing means that conducts edge enhancement or high-frequency component enhancement processing more for the smaller angle of field, when the angle of field estimated in the field angle estimating means is smaller than 10°.

The invention described in Item 85 is the image processing apparatus described in Item 78, wherein there is further included an inhibition processing means that conducts removal of granulated noise or medium frequency component inhibition processing more for the greater angle of field, when the angle of field estimated in the field angle estimating means is greater than 10°.

The invention described in Item 86 is the image processing apparatus described in Item 78, wherein there is further included a chroma enhancement means that enhances chroma more for the smaller angle of field when the angle of field estimated in the field angle estimating means is smaller than 10°.

The invention described in Item 87 is the image processing apparatus described in Item 78, wherein there is further included a chroma enhancement means that enhances chroma more for the greater angle of field when the angle of field estimated in the field angle estimating means is greater than 10°.

The image processing apparatus of the present invention can be obtained with the following items.

The invention described in Item 88 is represented by an image processing apparatus provided with a recording means to record image signals obtained by conducting a prescribed image processing on image signals indicating a photographed image, wherein there is included a processing content determining means that determines contents of the image processing based on an angle of field of a main photographed-subject that is positioned at a viewing distance for the outputted image.

The invention described in Item 89 is represented by an image processing apparatus provided with a recording means to record image signals obtained by conducting a prescribed image processing on image signals indicating a photographed image, wherein there are included a size information acquiring means that acquires a size of an output image and a size of a main photographed-subject in the output image, and a processing content determining means that determines contents of the image processing based on the size of the output image and the size of the main photographed-subject in the output image acquired in the size information acquiring means.

The invention described in Item 90 is represented by an image processing apparatus provided with a recording means to record image signals obtained by conducting a prescribed image processing on image signals indicating a photographed image, wherein there are included a size information acquiring means that acquires a size of an output image, a size estimating means that estimates a size of a main photographed-subject in the output image, based on a size of the output image acquired in the size information acquiring means and a processing content determining means that determines contents of the image processing based on a size of a main photographed-subject in the output image estimated in the size estimating means.

The invention described in Item 91 is represented by an image processing apparatus provided with a recording means to record image signals obtained by conducting a prescribed image processing on image signals indicating a photographed image, wherein there are included a rate information acquiring means that acquires an occupying rate of a main photographed-subject in the image, a size information acquiring means that acquires a size of an output image, a size estimating means that estimates a size of the main photographed-subject in the output image based on the occupying rate of the main photographed-subject acquired in the rate information acquiring means and the size of the output image acquired in the size information acquiring means and a processing content determining means that determines contents of the image processing based on the size of the main photographed-subject in the output image estimated in the size estimating means.

The invention described in Item 92 is represented by an image processing apparatus provided with a recording means to record image signals obtained by conducting a prescribed image processing on image signals indicating a photographed image, wherein there are included a condition information acquiring means that acquires information about photographing conditions, a rate estimating means that estimates an occupying rate of a main photographed-subject from information about the photographing conditions acquired in the condition information acquiring means, a size information acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and a processing content determining means that determines contents of the image processing based on a size of a main photographed-subject in the output image estimated in the size estimating means.

The invention described in Item 93 is represented by an image processing apparatus provided with a recording means to record image signals obtained by conducting a prescribed image processing on image signals indicating a photographed image, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information acquired in the condition information acquiring means, a size information-acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and a processing content determining means that determines contents of the image processing based on a size of a main photographed-subject in the output image estimated in the size estimating means.

The invention described in Item 94 is the image processing apparatus described in either one of Items 92 and 93, wherein in the condition information acquiring means, information about the photographing condition is acquired from tag information added to image signals indicating a photographed image.

The invention described in Item 95 is represented by an image processing apparatus provided with a recording means to record image signals obtained by conducting a prescribed image processing on image signals indicating a photographed image, wherein there are included a rate information acquiring means that acquires an occupying rate of a main photographed-subject in the image, a first size estimating means that estimates a size of an output image, a second size estimating means that estimates a size of the main photographed-subject in the output image based on the occupying rate of the main photographed-subject acquired in the rate information acquiring means and the size of the output image estimated in the first size estimating means and a processing content determining means that determines contents of the image processing based on the size of the main photographed-subject in the output image estimated in the second size estimating means.

The invention described in Item 96 is represented by an image processing apparatus provided with a recording means to record image signals obtained by conducting a prescribed image processing on image signals indicating a photographed image, wherein there are included a condition information acquiring means that acquires information about photographing conditions, a rate estimating means that estimates an occupying rate of a main photographed-subject from information about the photographing conditions acquired in the condition information acquiring means, a first size estimating means that estimates a size of an output image, a second size estimating means that estimates a size of the main photographed-subject in the output image based on the occupying rate of the main photographed-subject estimated in the rate estimating means and the size of the output image estimated in the first size estimating means and a processing content determining means that determines contents of the image processing based on the size of the main photographed-subject in the output image estimated in the second size estimating means.

The invention described in Item 97 is represented by an image processing apparatus provided with a recording means to record image signals obtained by conducting a prescribed image processing on image signals indicating a photographed image, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information regarding the photographing condition acquired in the condition information acquiring means, a first size estimating means that estimates a size of an output image from the information regarding the photographing condition acquired in the condition information acquiring means, a second size estimating means that estimates a size of the main photographed-subject in the output image based on the occupying rate of the main photographed-subject estimated in the rate estimating means and the size of the output image estimated in the first size estimating means and a processing content determining means that determines contents of the image processing based on the size of the main photographed-subject in the output image estimated in the second size estimating means.

The invention described in Item 98 is the image processing apparatus described in either one of Items 96 and 97, wherein in the condition information acquiring means, information about the photographing condition is acquired from tag information added to image signals indicating a photographed image.

The invention described in Item 99 is represented by an image processing apparatus provided with a recording means to record image signals obtained by conducting a prescribed image processing on image signals indicating a photographed image, wherein there is included a processing content changing means that changes contents of the image processing based on an angle of field of a main photographed-subject that is positioned at a viewing distance for the outputted image.

The invention described in Item 100 is represented by an image processing apparatus provided with a recording means to record image signals obtained by conducting a prescribed image processing on image signals indicating a photographed image, wherein there are included a size information acquiring means that acquires a size of an output image and a size of a main photographed-subject in the output image, and a processing content changing means that changes contents of the image processing based on the size of the output image and the size of the main photographed-subject in the output image acquired in the size information acquiring means

The invention described in Item 101 is represented by an image processing apparatus provided with a recording means to record image signals obtained by conducting a prescribed image processing on image signals indicating a photographed image, wherein there are included a size information acquiring means that acquires a size of an output image, a size estimating means that estimates a size of a main photographed-subject in the output image, based on a size of the output image acquired in the size information acquiring means and a processing content changing means that changes contents of the image processing based on a size of a main photographed-subject in the output image estimated in the size estimating means.

The invention described in Item 102 is represented by an image processing apparatus provided with a recording means to record image signals obtained by conducting a prescribed image processing on image signals indicating a photographed image, wherein there are included a rate information acquiring means that acquires an occupying rate of a main photographed-subject in the image, a size information acquiring means that acquires a size of an output image, a size estimating means that estimates a size of the main photographed-subject in the output image based on the occupying rate of the main photographed-subject acquired in the rate information acquiring means and the size of the output image acquired in the size information acquiring means and a processing content changing means that changes contents of the image processing based on the size of the main photographed-subject in the output image estimated in the size estimating means.

The invention described in Item 103 is represented by an image processing apparatus provided with a recording means to record image signals obtained by conducting a prescribed image processing on image signals indicating a photographed image, wherein there are included a condition information acquiring means that acquires information about photographing conditions, a rate estimating means that estimates an occupying rate of a main photographed-subject from information about the photographing conditions acquired in the condition information acquiring means, a size information acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and processing content changing means that changes contents of the image processing based on a size of a main photographed-subject in the output image estimated in the size estimating means.

The invention described in Item 104 is represented by an image processing apparatus provided with a recording means to record image signals obtained by conducting a prescribed image processing on image signals indicating a photographed image, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information acquired in the condition information acquiring means, a size information acquiring means that acquires a size of an output image, a size estimating means that estimates a size of a main photographed-subject in the output image, based on information showing the occupying rate of the main photographed-subject estimated in the rate estimating means and a size of the output image acquired in the size information acquiring means and processing content changing means that changes contents of the image processing based on a size of a main photographed-subject in the output image estimated in the size estimating means.

The invention described in Item 105 is the image processing apparatus described in either one of Items 103 and 104, wherein in the condition information acquiring means, information about the photographing condition is acquired from tag information added to image signals indicating a photographed image.

The invention described in Item 106 is represented by an image processing apparatus provided with a recording means to record image signals obtained by conducting a prescribed image processing on image signals indicating a photographed image, wherein there are included a rate information acquiring means that acquires an occupying rate of a main photographed-subject in the image, a first size estimating means that estimates a size of an output image, a second size estimating means that estimates a size of the main photographed-subject in the output image based on the occupying rate of the main photographed-subject acquired in the rate information acquiring means and the size of the output image estimated in the first size estimating means and processing content changing means that changes contents of the image processing based on the size of the main photographed-subject in the output image estimated in the second size estimating means.

The invention described in Item 107 is represented by an image processing apparatus provided with a recording means to record image signals obtained by conducting a prescribed image processing on image signals indicating a photographed image, wherein there are included a condition information acquiring means that acquires information about photographing conditions, a rate estimating means that estimates an occupying rate of a main photographed-subject from information about the photographing conditions acquired in the condition information acquiring means, a first size estimating means that estimates a size of an output image, a second size estimating means that estimates a size of the main photographed-subject in the output image based on the occupying rate of the main photographed-subject estimated in the rate estimating means and the size of the output image estimated in the first size estimating means and processing content changing means that changes contents of the image processing based on the size of the main photographed-subject in the output image estimated in the second size estimating means.

The invention described in Item 108 is represented by an image processing apparatus provided with a recording means to record image signals obtained by conducting a prescribed image processing on image signals indicating a photographed image, wherein there are included a condition information acquiring means that acquires information about at least one photographing condition among a subject area, a photographing scene type, a subject distance and a detection of reflected light of electronic flash, a rate estimating means that estimates an occupying rate of a main photographed-subject from information regarding the photographing condition acquired in the condition information acquiring means, a first size estimating means that estimates a size of an output image from the information regarding the photographing condition acquired in the condition information acquiring means, a second size estimating means that estimates a size of the main photographed-subject in the output image based on the occupying rate of the main photographed-subject estimated in the rate estimating means and the size of the output image estimated in the first size estimating means and processing content changing means that changes contents of the image processing based on the size of the main photographed-subject in the output image estimated in the second size estimating means.

The invention described in Item 109 is the image processing apparatus described in either one of Items 107 and 108, wherein in the condition information acquiring means, information about the photographing condition is acquired from tag information added to image signals indicating a photographed image.

The invention described in Item 110 is the image processing apparatus described in either one of Items 88-109, wherein there are further included a processing tendency acquiring means that acquires a tendency of image processing conducted when image signals indicating a photographed image are generated, and a correction means that corrects a level of image processing based on information showing the tendency of the image processing acquired in the processing tendency acquiring means.

The invention described in Item 111 is the image processing apparatus described in either one of Items 88-109, wherein there are further included a processing tendency acquiring means that acquires at least one image processing tendency among contrast processing, sharpness processing, graininess processing and chroma processing, and a correction means that corrects a level of the image processing based on information showing the tendency of the image processing acquired in the processing tendency acquiring means.

The invention described in Item 112 is the image processing apparatus described in either one of Items 110 and 111, wherein the correction means corrects, based on the tendency of image processing conducted when image signals indicating a photographed image are generated, in the form wherein overlapping and reciprocity between the contents of correction about the level of the image processing and the image processing conducted in the course of photographing are taken into consideration.

The invention described in Item 113 is the image processing apparatus described in either one of Items 110-112, wherein the processing tendency acquiring means acquires a tendency of the image processing conducted when image signals indicating a photographed image are generated, from tag information added to the image signals indicating the photographed image.

The invention described in Item 114 is the image processing apparatus described in either one of Items 88-113, wherein there are further included a preference tendency acquiring means that acquires a preference tendency of a user and a processing level setting means that establishes a level of the image processing based on information showing the user's preference tendency acquired in the preference tendency acquiring means.

The invention described in Item 115 is the image processing apparatus described in either one of Items 88-113, wherein there are further included a preference tendency estimating means that estimates a preference tendency of user and a processing level setting means that establishes a level of the image processing based on information showing the user's preference tendency estimated in the preference tendency estimating means.

The invention described in Item 116 is the image processing apparatus described in either one of Items 88-113, wherein there are further included an establishment information acquiring means that acquires at least one piece of information about setting of a model of photographing apparatus, the number of pixels for photographing, exposure mode and white balance, a preference tendency estimating means that estimates a user's preference tendency from the information acquired in the establishment information acquiring means and a processing level setting means that establishes a level of the image processing based on information showing the user's preference tendency estimated in the preference tendency estimating means.

The invention described in Item 117 is the image processing apparatus described in either one of Items 88-113, wherein there are further included a preference tendency acquiring means that acquires a preference tendency of a user and a processing level revising means that revises a level of the image processing based on information showing the user's preference tendency acquired in the preference tendency acquiring means.

The invention described in Item 118 is the image processing apparatus described in either one of Items 88-113, wherein there are further included a preference tendency estimating means that estimates a preference tendency of user and a processing level revising means that revises a level of the image processing based on information showing the user's preference tendency estimated in the preference tendency estimating means.

The invention described in Item 119 is the image processing apparatus described in either one of Items 88-70, wherein there are further included an establishment information acquiring means that acquires at least one piece of information about setting of a model of photographing apparatus, the number of pixels for photographing, exposure mode and white balance, a preference tendency estimating means that estimates a user's preference tendency from the information acquired in the establishment information acquiring means and a processing level revising means that revises a level of the image processing based on information showing the user's preference tendency estimated in the preference tendency estimating means.

The invention described in Item 120 is the image processing apparatus described in either one of Items 114-119, wherein there is further included a preference judging information acquiring means that acquires preference judging information used for acquiring or estimating a user's preference from tag information added to the image signals indicating the photographed image.

The invention described in Item 121 is the image processing apparatus described in either one of Items 88-120, wherein there are further included an field angle estimating means that estimates an angle of field by which a main photographed-subject is covered when an image is observed and a content changing means that changes contents of the image processing according to the angle of field estimated in the field angle estimating means.

The invention described in Item 122 is the image processing apparatus described in Item 121, wherein there is further included a content changing means that changes contents of the image processing depending on whether the angle of field estimated in the field angle estimating means can be covered by 10° or not.

The invention described in Item 123 is the image processing apparatus described in Item 121, wherein there is further included a contrast-increasing means that increases contrast more for the smaller angle of field, when the angle of field estimated in the field angle estimating means is smaller than 10°.

The invention described in Item 124 is the image processing apparatus described in Item 121, wherein there is further included a means to increase contrast by 5% or more that increases contrast 5% or more when the angle of field estimated in the field angle estimating means is smaller than 10°.

The invention described in Item 125 is the image processing apparatus described in Item 121, wherein there is further included a contrast-reduction means that reduces contrast more for the greater angle of field, when the angle of field estimated in the field angle estimating means is greater than 10°.

The invention described in Item 126 is the image processing apparatus described in Item 121, wherein there is further included a means to decrease contrast by 5% or more that decreases contrast 5% or more when the angle of field estimated in the field angle estimating means is greater than 10°.

The invention described in Item 127 is the image processing apparatus described in Item 121, wherein there is further included an enhancement processing means that conducts edge enhancement or high-frequency component enhancement processing more for the smaller angle of field, when the angle of field estimated in the field angle estimating means is smaller than 10°.

The invention described in Item 128 is the image processing apparatus described in Item 121, wherein there is further included an inhibition processing means that conducts removal of granulated noise or medium frequency component inhibition processing more for the greater angle of field, when the angle of field estimated in the field angle estimating means is greater than 10°.

The invention described in Item 129 is the image processing apparatus described in Item 121, wherein there is further included a chroma enhancement means that enhances chroma more for the smaller angle of field when the angle of field estimated in the field angle estimating means is smaller than 10°.

The invention described in Item 130 is the image processing apparatus described in Item 121, wherein there is further included a chroma enhancement means that enhances chroma more for the greater angle of field when the angle of field estimated in the field angle estimating means is greater than 10°.

The invention described in Item 131 is the image processing apparatus described in either one of Items 88-130, wherein the recording means is a device to print out.

The invention described in Item 132 is the image processing apparatus described in either one of Items 88-130, wherein the recording means is a device to print out on a silver halide photographic paper.

The invention described in Item 133 is the image processing apparatus described in either one of Items 88-130, wherein the recording means is a device to print out with an ink-jet method.

The invention described in Item 134 is the image processing apparatus described in either one of Items 88-130, wherein the recording means is a device to print out with an electro-photographic method.

The invention described in Item 135 is the image processing apparatus described in either one of Items 88-130, wherein the recording means is a device to print out with a sublimating method.

The invention described in Item 136 is the image processing apparatus described in either one of Items 88-130, wherein the recording means is a device to print out with a thermal method.

The invention described in Item 137 is the image processing apparatus described in either one of Items 88-130, wherein the recording means is a device to record signals in a recording medium.

The invention described in Item 138 is the invention described in Item 137, wherein the recording medium is at least one of CD-R, CD-RW, MD, a memory card, an IC card, a floppy disk and a optical magnetic disk.

### BRIEF DESCRIPTION OF THE DRAWINGS

FIG. 1 is a graph showing the correlation between an observation distance and a length of a longer side of an image.

FIG. 2 is a graph showing the correlation between a contrast ratio and an angle of field of a main photographed-subject.

FIG. 3 is a graph showing the correlation between a degree of enhancement of sharpness and an angle of field of a main photographed-subject.

FIG. 4 is a graph showing the correlation between a degree of retardation of graininess and an angle of field of a main photographed-subject.

FIG. 5 is a graph showing the correlation between a degree of enhancement of chroma and an angle of field of a main photographed-subject.

FIG. 6 is a graph showing the correlation between a gain of medium frequency component and an angle of field of a main photographed-subject.

FIG. 7 is a graph showing the correlation between a gain of high frequency component and an angle of field of a main photographed-subject.

FIG. 8 is an outside structure diagram of image recording apparatus 1 to which the invention is applied.

FIG. 9 is a block diagram showing an internal structure of image recording apparatus 1 to which the invention is applied.

FIG. 10 is a functional block diagram showing functions owned by image processing section 70 shown in FIG. 9.

FIG. 11 is a flow chart illustrating image adjustment processing in image recording apparatus 1.

FIG. 12 is a flow chart illustrating processing of estimating a size of a main photographed-subject within an exposed image in image recording apparatus 1.

FIG. 13 is a flow chart illustrating processing of determining contents of image processing in image recording apparatus 1.

### DETAILED DESCRIPTION OF THE PREFERRED EMBODIMENT

Next, the structure of the invention will be explained in a more detailed way.

The “image signals indicating a photographed image” stated above means image data generated by a photographing means such as a digital camera, image data obtained by making photographed image to be electronic ones with a film scanner or a flat-bed scanner, and data obtained after the aforesaid data have been subjected to processing or form conversion conducted by various application programs. More concretely, the image signals are constructed in a form of two dimensionally-arranged image data representing a photographed image. With respect to a form of data, an all-purpose format represented by JPEG, TIFF and Exif and a format that is peculiar in terms of a model and application are given as an example, and they are given to the embodiment of the invention through media such as a hard disk, CD-ROM, a memory card and a floppy disk or through communication lines. “To conduct prescribed image processing and to generate image signals for output” stated above means an action to generate image signals corrected by adding image processing which will be described later to the image signals indicating a photographed image, so that favorable impression may be given when the image is observed on the medium (hereinafter referred to as output medium) on which photographed image are outputted. The image signals generated in the invention are sent as they are to a printer in the apparatus or a printer connected to communication lines, or preserved or transmitted through media such as a hard disk, CD-ROM, a memory card and a floppy disk or through communication lines, in an all-purpose format represented by JPEG, TIFF and Exif or in various formats represented in a peculiar way in terms of a model and application.

The “main photographed-subject” stated above is a subject which is looked to play a central role in a representation when a photographer establishes composition of photographed image, and it is a person, in particular, a face area in many cases. Even in the case of a landscape photograph including no person, it is a rare case that the composition is established aimlessly, and flowers, animals and still lives in the foreground are main photographed-subjects in some cases, while, mountains, skies and clouds in the background are main photographed-subjects in another case.

The “size of output image” mentioned above means an actual size of an entire exposed image area printed or displayed on a medium, and when printed on a sheet of A4 size, for example, an area of about 190 mm×280 mm excluding a margin for edging is a size of output image.

The “size of a main photographed-subject in output image” mentioned above means an actual size of a main photographed-subject area printed or displayed on a medium. Even in the case of being printed on the sheet of the same A4 size, for example, the size is a 50 mm square to a 100 mm square in a close-up photograph of a person in many cases and the size is a 10 mm square to a 30 mm square in a group photo or souvenir photographing with a background of a building for a person in many cases. Even in the case where a size of output image is constant as stated above, a size of a main photographed-subject in output image is dependent upon the composition intended by a photographer, and it varies in each image.

The invention is characterized in that the contents of image processing applied to image signals indicating a photographed image are established, based on the “size of output image” and “size of main photographed-subject in output image”, so that favorable impression may be made when images are observed on an output medium. An embodiment of the concrete change of contents of image processing will be explained in detail later.

In the aforesaid method for “obtaining a size of output image”, a size of output image can be obtained easily from contents of instructions for printing when the embodiment of the invention is an image processing apparatus connected to an image recording apparatus or a printer, and a size of output image can be obtained by the embodiment of the invention when a user specifies a size of estimated output image, even when the embodiment of the invention is an image processing method or an image processing apparatus which is not connected directly to the printer and outputs image data to the file or to the communication means.

Further, even when a size of output image cannot be obtained, the invention can be executed by “estimating a size of output image”. For example, the number of pixels of output image correlates strongly with a size on an output medium intended by a user. An image with about 10000 pixels is used for a thumbnail index, and a size of output image is estimated to be intended to be about several centimeters square, and an image with about 2000000 pixels is estimated to be intended for prints of L−2L sizes. The simplest method to estimate a size of output image is attained by converting the number of pixels of an image into a size of output image, by assuming printing conditions (for example, 300 DPI) for general color images.

The method “to obtain a size of a main photographed-subject in output image” is attained by accepting the specification when a command is given to the embodiment of the invention and by referring to added information (so-called tag information) attached to image signals indicating a photographed image. With respect to the method to attach this added information, the added information may be given as original information format or as independent information file of signals. However, as an embodiment that is more preferable, it is possible to use existing tag information stipulated in various all-purpose image formats represented by JPEG, TIFF and Exif, or to use an area which can be used freely such as a maker note or a user note.

A size of a main photographed-subject is not always specified in an actual size on output image, and it is also possible to give information which can calculate “the rate occupied by a main photographed-subject on an image” by the means similar to the foregoing. For example, when a size of a main photographed-subject is given as the number of pixels on one side or on a radius, the rate occupied by the main photographed-subject on an image can be calculated easily by comparing with the number of pixels for the entire image, and when it is multiplied by a size of output image obtained or estimated by the invention through the aforesaid method, a size of the main photographed-subject on output image can be calculated easily.

Even in the case where a size of a main photographed-subject is not specified directly, it is possible to execute the invention by “estimating a size of a main photographed-subject in output image”. Though there are given concretely a method to extract a flesh color portion from image signals and a method to extract a range wherein hue and lightness are constant, the method which is more preferable is one to “obtain information about photographing conditions and to estimate from the information a rate occupied by a main photographed-subject. As a practical example of information about photographing conditions, there are given an area of a subject, a scene type for photographing, a subject distance and detection of a stroboscopic reflected light. Though these pieces of information may be given as an original information format and original information file and signals, the more preferable embodiment is to refer to existing tag information stipulated in various types of all-purpose image formats represented by JPEG, TIFF and Exif, or to use an area that can be used freely such as a maker note or a user note.

There will be explained a method to estimate a rate occupied by a main photographed-subject based on information about photographing conditions, by giving examples.

With respect to the occasion where information of an area of a subject has been given, for example, if this information has been provided in a form wherein the number of pixels in an area can be calculated as in the number of pixels for the central coordinates and a radius of a circular area or for the central coordinates and the longitudinal and the lateral directions of a rectangular area, the rate occupied by a main photographed-subject can be calculated easily in an image by comparing the number of pixels of the total image, and it is possible to calculate a size of the main photographed-subject in output image easily, by multiplying the calculated rate by a size of the output image obtained or estimated through the aforesaid method in the invention. When information of an area of a subject is given with only one point of the central coordinates of the area, it is possible to confirm the number of pixels of the primary subject area by calculating average hue and average lightness of several pixels on the periphery of the specified coordinates and by searching pixel areas whose hue and lightness are included in a certain range (for example, a difference of hue angles is within 10° and a difference of lightness is within 10% of a dynamic range) from the average values in the periphery of the specified central coordinates.

Further, when information of a type of photographing scene is given, a main photographed-subject is a face of a person in the case of photographing of a person or a portrait, and its diameter is estimated to be about ¼-½ of a shorter side of an image. As a rough value, by using equally the number of pixels equivalent to an area of a circle with a diameter of about one third of the number of pixels for a shorter side of an image, the rate occupied by the main photographed-subject can be estimated, and by searching the flesh color area of about ¼-½ of a shorter side of an image from the image, estimating accuracy can be improved. Further, when a photographing scene type is represented by a scene, a main photographed-subject occupies about 10% of the image area in many cases. Further, when a photographing scene type is represented by a night view, an area whose lightness is higher when comparing with the total image can be estimated as a main photographed-subject. When information of a subject distance is given, it is possible to estimate a rate occupied by a main photographed-subject in an image, by assuming that a main photographed-subject is a face of a person, and by calculating a size of a face in accordance with a subject distance based on lens characteristics of a general compact camera.

When information of stroboscopic reflected light is given, a rough subject distance can be estimated by information of presence and intensity of reflected light, and the rate occupied by the main photographed-subject in the image can be estimated through the same method as in the foregoing. When plural pieces of photographing information are given, it is naturally possible to improve accuracy of estimation by combination of information and by judgment.

The invention is characterized to determine the contents of the image processing to be applied to image signals indicating a photographed image based on “a size of output image” and “a size of a main photographed-subject in output image” obtained or estimated through the aforesaid method, so that more favorable impression may be given when an image is observed on an output medium. An actual embodiment of image processing will be explained as follows.

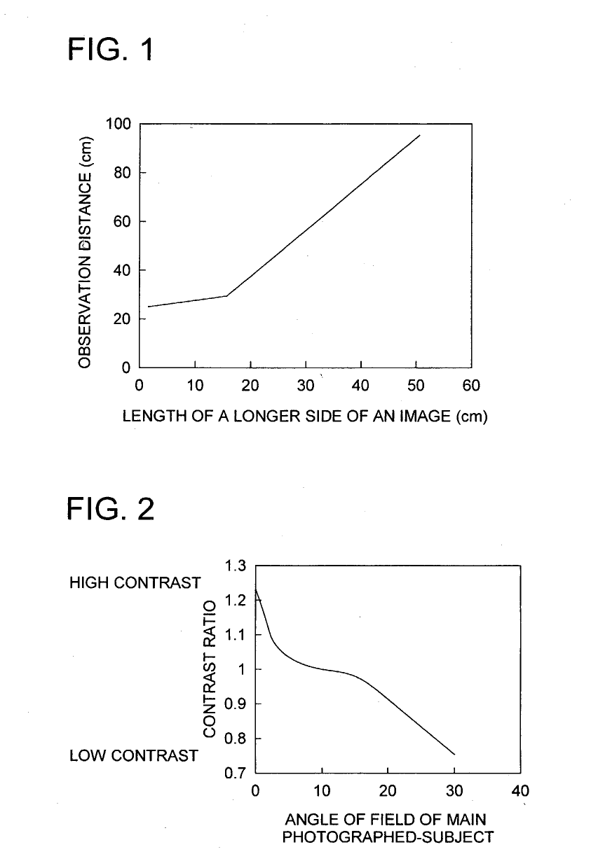

When a person appreciates photographed image displayed on a medium or on a print, its general distance for appreciation varies depending on “a size of output images”. An appreciation distance for an image size corresponding to photographic sizes of L (86 mm×128 mm)−2L (128 mm×172 mm) is about 30 cm, and when the image is greater, the appreciation distance is longer so that a visual field may cover the total image. In many cases, this distance is represented by a distance wherein a longer side of an image can be covered within about 30° of an angle of field. Even when an image is small, on the contrary, it does not happen that the appreciation distance is much shorter than 30 cm. This relationship is shown in FIG. 1. Incidentally, the exposed image mentioned here means the so-called photographic image photographed by the means such as a film camera and a digital camera. For example, when a picture frame illustration is written on an output medium, and photographed image are enchased within the illustration serving as a template, the appreciation distance is not controlled by a size of the picture frame illustration but is controlled by a size of inner photographed image, in general. Therefore, “a size of output image” in the invention means a size of photographed image for appreciation which are inside the template. When a plurality of photographed image each being different in terms of size are enchased in the same template, a size of output image is defined separately for the respective photographed image.

On the other hand, an impression given to an appreciator by an image depends on how the main photographed-subject located at the aforesaid observation distance looks. It is generally said that resolution in the sense of sight of a person is high in a range of 10° in terms of an angle of field, and in the case of an appreciation distance of 30 cm, for example, a range of a diameter of about 5 cm corresponds to a range of an angle of field 100. The angle of field is defined by the following expression;

Numeral 1

$$φ = 2 \cdot {tan}^{- 1} ( \frac{d}{r} ) \qquad Numeral 1$$

wherein, θ represents an angle of field, d represents a radius of a main photographed-subject and r represents an observation distance.

When a size of a main photographed-subject on an image is smaller than a range of angle of field 10°, sharp pictures each having high contrast and a sharp contour are preferred. For example, if a face is a main photographed-subject and its diameter is as small as 5 cm or less, a photograph with clearly-marked features is preferred. In particular, if a diameter of a face is about 1 cm-2 cm as in a group photo, a picture with high contrast which makes it easy to discriminate is preferred. When the main photographed-subject is greater than a range of an angle of field 100, on the contrary, a picture with low contrast that gives soft impression is preferred. For example, if a face is a main photographed-subject and its diameter is 10 cm, a partial skin of the face is covered by the range for an angle of field of 100. Under this condition, if contrast is too high and sharpness is too strong, an impression of grainy skin and an impression that shadows of the eyes and the nose are too strong are given, and a sense of incompatibility is given to a change of chroma of a microscopic part. In this case, if the contrast is made to be low and sharpness and a chroma change are made to be moderate, a skin gives a smooth and young and fresh impression.

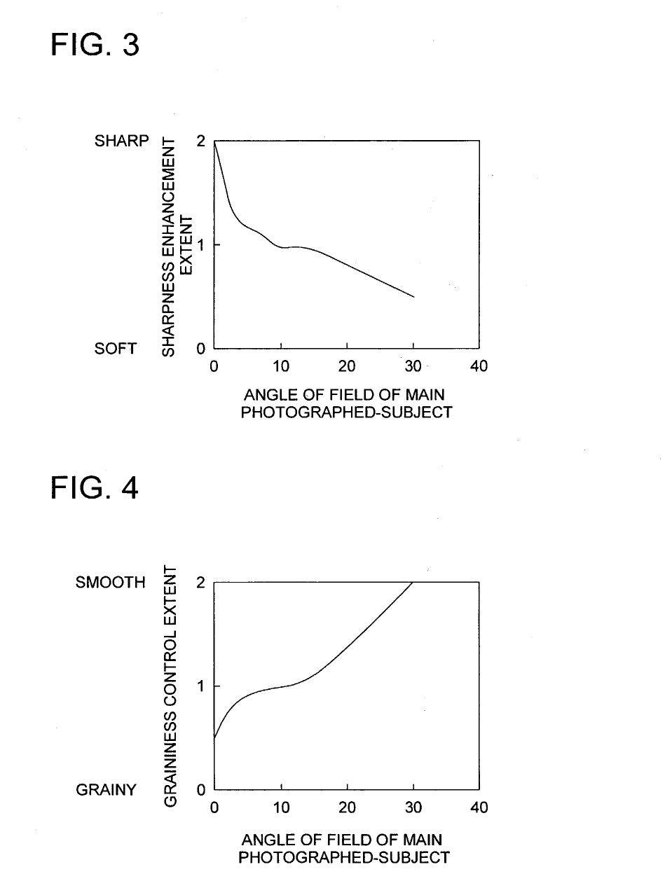

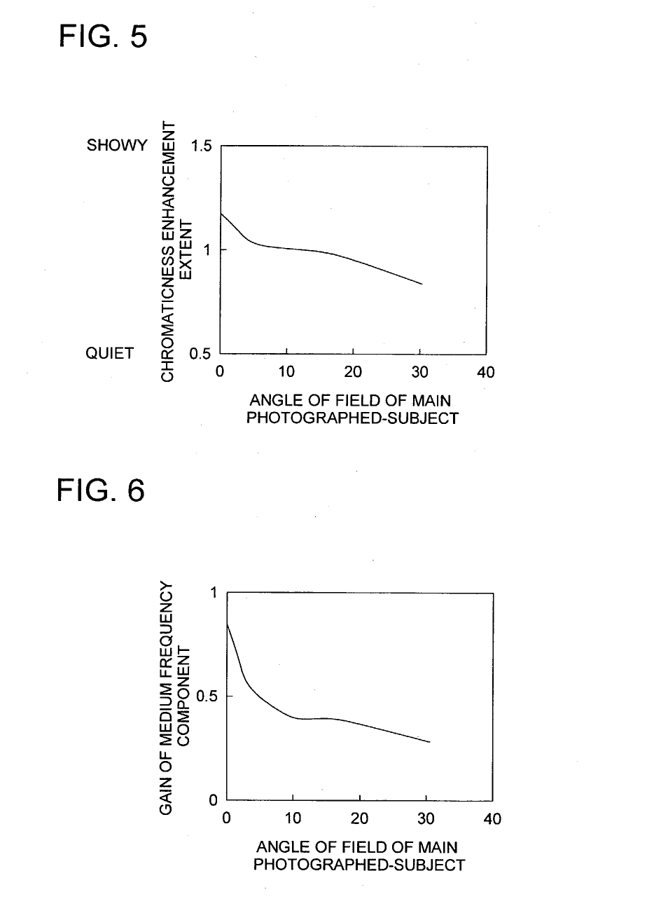

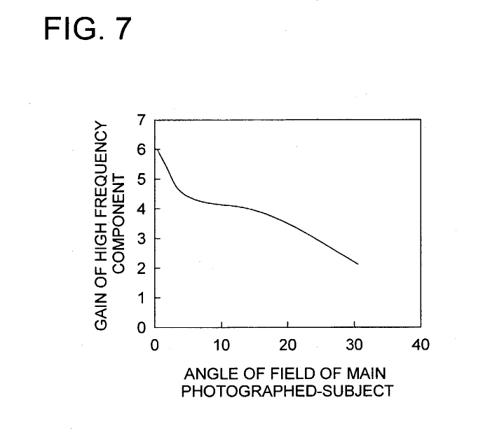

In the preferable embodiment of the method to determine the contents of image processing to be applied to image signals indicating a photographed image, an appreciation distance is estimated from “a size of output image” and an angle of field for the total main photographed-subject is estimated from the appreciation distance and “a size of a main photographed-subject in output image” both based on the empirical rule, and establishment of contrast of images, a degree of enhancement of sharpness, a degree of control of granulated noise and a degree of enhancement of chroma are controlled in accordance with the angle of field for the total main photographed-subject, resulting in that it is possible to make a favorable impression when an image is observed on an output medium. An example is shown in FIGS. 2-5. When employing a technology to use control of medium frequency component represented by TOKKAI No. 2000-215307 and enhancement of high frequency component jointly, it is preferable to control the establishment of the control of medium frequency component and the enhancement of high frequency component, depending on the angle of field for the total main photographed-subject. An example is shown in FIGS. 6 and 7. Incidentally, with respect to a definition of the medium frequency component and high frequency component mentioned in this case, it is described in detail in the aforesaid specification.

Incidentally, in this case, image processing conditions were determined by calculating an appreciation distance and an angle of field for the total main photographed-subject from “a size of output image” and “a size of a main photographed-subject in output image”, just for explanation. In the actual embodiment, however, it is not necessary to make the aforesaid calculation each time image signals indicating a photographed image are received, and it is preferable to determine the image processing conditions by referring to a look-up table on which image processing conditions corresponding to “a size of output image” and “a size of a main photographed-subject in output image” are described or to a simple expression for approximate calculation.

Further, in the invention, it is preferable to acquire the tendency of image processing conducted when image signals indicating a photographed image are generated, and to correct the extent of the image processing based on the information of the tendency of image processing. To be concrete, for example, it is preferable to acquire an image processing tendency such as contrast processing, sharpness processing and chroma processing which are conducted when image signals indicating a photographed image are generated, and to correct the extent of the image processing based on the information. As a method for acquiring information concerning this image processing tendency, though information may be acquired as an original information format or as an independent information file and signals, the more preferable mode is to refer to existing tag information stipulated in various all-purpose image formats represented by JPEG, TIFF and Exif, or to use an area that can be used freely such as a maker note and a user note. If the contrast is already established to be high based on the aforesaid information in the course of photographing, for example, it is possible to put image characteristics of output image in an appropriate range by correcting the extent of image processing in the invention under consideration of overlapping with image processing in the course of photographing and of reciprocity, including controlling or abolishing contrast enhancement in the case of a main photographed-subject on an image that is smaller than a range of angle of field 100, or raising the extent of contrast reduction in the case of a main photographed-subject on an image that is greater than a range of angle of field 100.

Further, in the invention, it is preferable that information about the tendency of the user's taste is acquired together and the extent of the image processing is corrected based on that information. As a method to acquire information about the user's taste, it is possible to specify the tendency of taste such as hard, soft, showy, quiet and fidelity for input, when a user gives instructions to the embodiment of the invention, or to make the specified information for the tendency of taste to be included in an original information format or in an independent information file and signals. However, the more preferable mode is to record the tendency of taste on the existing tag information stipulated in various all-purpose image formats represented by JPEG, TIFF and Exif, or on an area that can be used freely such as a maker note and a user note.

Further, even when it is impossible to acquire information about the tendency of taste of a user, it is preferable to estimate the tendency of taste of a user and to correct the extent of the image processing based on the results of the estimation. As information used for estimating the tendency of taste of a user, there are given some pieces of information including those concerning, for example, a photographing equipment model, the number of pixels of photographing, an exposure mode and white balance setting. These pieces of information may be specified when a user gives instructions to the embodiment of the invention, or may be specified by describing the information on an original information format or on an independent information file and signals. However, the more preferable mode is to acquire the information by referring to the existing tag information stipulated in various all-purpose image formats represented by JPEG, TIFF and Exif, or to an area that can be used freely such as a maker note and a user note. For example, when a photographing equipment is a high-grade machine such as an SLR digital camera, there is a high possibility that a skill of a photographer is high, and photographing conditions and establishment of photographing mode have been determined by considering the state to appreciate images printed or displayed on a medium, and a composition has been determined by considering a position and a size of a main photographed-subject in an image. Therefore, it is preferred that the image processing conducted in each of an image processing method, an image processing apparatus and an image recording apparatus is made to be moderate. Even when a photographing equipment model is unknown, when the number of pixels for photographing is so many from the viewpoint of the market of the times, the photographing is judged to be conducted by the high-grade machine, and the estimation stated above can be applied. Further, when an exposure mode and a white balance are established manually and photographing is conducted through an automatic blanket mode, it is sure that photographing conditions and a photographing mode are established by a photographer with a clear intension. It is therefore preferable that the image processing that is conducted in each of an image processing method, an image processing apparatus and an image recording apparatus is made to be moderate or is deterred completely.

As stated above, if the technology of the invention is used, it is possible to realize, with a simple and all-purpose way, an image processing method, an image processing apparatus and an image recording apparatus each of which gives an image that gives favorable impression when observing the image on the output medium, without conducting calculation with high load, only by acquiring or estimating simple and plain information such as “a size of output image” and “a size of a main photographed-subject in output image”. It is further possible to obtain a stable effect by acquiring the tendency of image processing in the course of photographing, or acquiring or estimating the tendency of user's taste. Further, by acquiring information needed by the invention from the so-called tag information added to image signals indicating a photographed image, or by estimating information needed by the invention from the tag information, it is possible to realize an image processing method, an image processing apparatus and an image recording apparatus which can be adapted to complicated environment where image signals indicating a photographed image generated by various types of photographing equipment are mingled and received through media and communication means.

A practical embodiment of each of the image processing method of the invention, the recording medium on which the program executing the image processing method is recorded, the image processing apparatus and the image recording apparatus will be explained as follows, referring to FIGS. 1-13.

Image adjustment processing section 70b explained below realizes a function owned by each of a processing content determining means that determines contents of image processing, a size information acquiring means that acquires a size of output image or a size of a main photographed-subject, a first size estimating means that estimates a size of output image, (a second) size estimating means that estimates a size of a main photographed-subject, a rate information acquiring means that acquires a rate occupied by a main photographed-subject in an image, a condition information acquiring means that acquires information about photographing conditions, a processing content changing means that changes contents of image processing, a processing tendency acquiring means that acquires an image processing tendency, a correcting means that corrects the extent of image processing, a taste tendency acquiring means that acquires a taste tendency of a user, a processing extent setting means that sets the extent of image processing, a setting information acquiring means that acquires at least one piece of information concerning a photographing equipment model, the number of pixels for photographing, an exposure mode and white balance setting, a taste judgment information acquiring means that acquires taste judgment information from tag information, an angle of field estimating means that estimates an angle of field, a content changing means that changes image processing contents in accordance with the estimated angle of field, a contrast increasing means that increases contrast, a means to increase contrast by 5% or more that increases contrast by 5% or more, a contrast reducing means that reduces contrast, a means to reduce contrast by 5% or more that reduces contrast by 5% or more, an enhancement processing means that conducts edge enhancement or high frequency component enhancement processing, a control processing means that conducts removal of granulated noise or medium frequency component control processing, and a chroma enhancement means that enhances chroma.

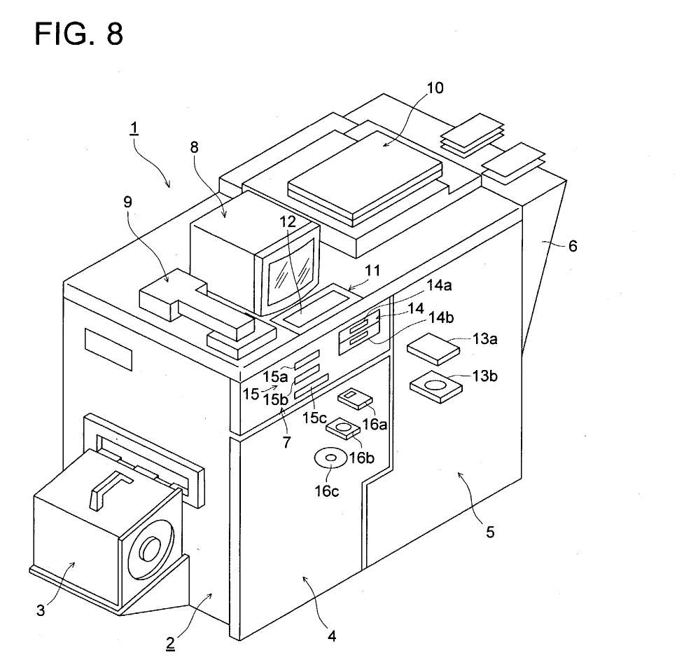

FIG. 8 is an outside structure diagram of image recording apparatus 1 to which the invention is applied. Though there is illustrated image recording apparatus 1 wherein a photosensitive material is exposed to light and is developed to make a print, the invention has only to be one which can make a print based on image information, and a print forming apparatus of an ink jet mode, an electrophotographic mode or a sublimation mode, for example, may also be used.

On the image recording apparatus 1, magazine loading section 3 is provided on the left side of main body 2, and inside the main body 2, there are arranged exposure processing section 4 by which a photosensitive material representing a recording medium is exposed to light, and print making section 5 wherein the exposed photosensitive material is developed and dried to become a print, and the print thus made is ejected to tray 6 provided on the right side of the main body 2. Further, inside the main body 2, control section 7 is arranged above the exposure processing section 4.

On the main body 2, there is arranged CRT 8 which has a function as a display means that displays photographed image to be printed. On the left side of CRT 8, there is arranged film scanner section 9 representing a transmission-type document reading apparatus, and on the right side of CRT 8, there is arranged reflection-type document inputting apparatus 10.

As a document to be read by the film scanner section 9 or by the reflection-type document inputting apparatus 10, there is given a photographic photosensitive material which includes a color negative film, a color reversal film, a black and white film and a black and white reversal film, and frame image information picked up by an analog camera is recorded on the photographic photosensitive material. A film scanner of the film scanner section 9 can convert into digital information to be frame image information. Further, when the photographic photosensitive material is a color paper, a flat-bed scanner of the reflection-type document inputting apparatus 10 can convert to frame image information.

Further, image reading section 14 is provided at the position where the control section 7 for the main body 2 is arranged. The image reading section 14 is equipped with adaptor 14a for PC card and adaptor 14b for FD (Floppy (registered trade mark) disk), and PC card 13a and FD 13b can be inserted into the image reading section 14. The PC card 13a has a memory in which a plurality of frame image information picked up by digital camera Q2 are stored. FD 13b stores, for example, a plurality of frame image information picked up by digital camera Q2.

In front of CRT 8, there is arranged operation section 11 on the top of main body 2, and the operation section 11 is provided with information input means 12 which is composed, for example, of a touch panel.

As a recording medium having frame image information relating to the invention other than the foregoing, there are given a multi-media card, a memory stick, MD data and CD-ROM.

Incidentally, though the operation section 11, CRT 8, film scanner section 9, the reflection-type document inputting apparatus 10 and the image reading section 14 are structured to be provided solidly on the main body 2, either one or more of them may be provided separately.

Further, on the arrangement position on the control section 7 for the main body, there is provided image writing section 15 which is equipped with adaptor 15a for FD, adaptor 15b for MO, and adaptor 15c for an optical disk, and FD16a, MO 16b and optical disk 16C can be inserted into the image writing section 15 so that various information may be written in these media.

Further, the control section 7 is provided with an un-illustrated communication means, and hereby, image recording apparatus 1 can function as the so-called network printer apparatus that directly receives image signals which indicate photographed image and a command for printing from the remote computer connected with another computer in the facilities or with the Internet.

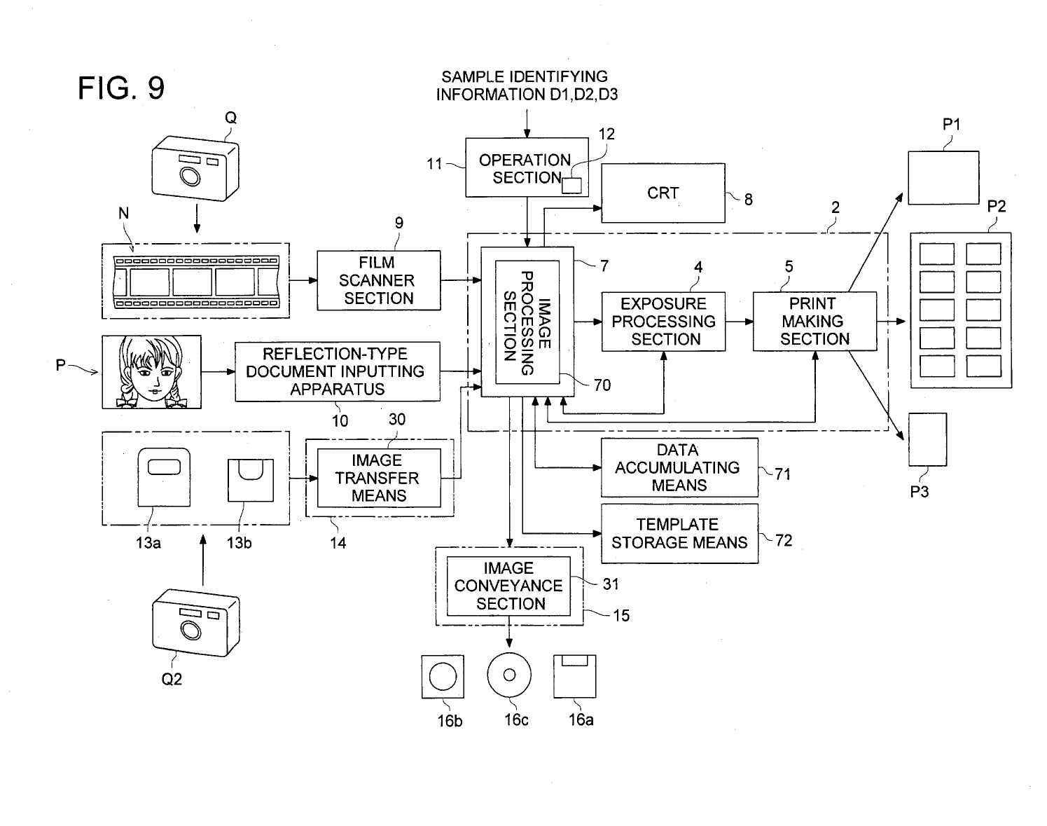

Next, an inner structure of the image recording apparatus 1 will be explained. FIG. 9 is a block diagram showing an internal structure of image recording apparatus 1 to which the invention is applied.

The control section 7 reads document information through film scanner section 9 and the reflection-type document inputting apparatus 10, in accordance with instruction information from the information input means 12, and displays on CRT 8.

Data accumulating means 71 stores image information and its corresponding order information (information showing the frame image and the number of prints to be made, information about print sizes) and accumulates them in succession. Film scanner section 9 reads frame image data from developed negative film N obtained by photographing by analog camera Q1, while, the reflection-type document inputting apparatus 10 reads frame image data of print P obtained by printing frame images on a photographic paper and by processing them for development.

Template storage means 72 stores sample image data (data showing background image and illustration images) associating with sample identifying information D1, D2 and D3, and stores at least one of data of a template that establishes a composition area with the sample image data. In this case, when a prescribed template is selected by an operation of an operator (this operation of the operator is based on instructions of a client) from a plurality of templates stored in template storage means 72 in advance, the control section 7 compounds frame image information and this selected template, and then, when sample identifying information D1, D2 and D3 are specified by an operation of the operator (the operation of the operator is based on instructions of a client), the control section 7 selects sample image data based on the specified sample identifying information D1, D2 and D3, and compounds the selected sample image data and image data and/or character data ordered by a client, thus, a print based on the sample image data desired by a client, as a result. This composition by means of a template is conducted by a known chromakey method.

Incidentally, types of the sample identifying information are not limited to three types of sample identifying information D1, D2 and D3, and the number of the types may also be greater or smaller than three.

Further the control section 7 has image processing section 70 which will be described later, and the image processing section 7 conducts image processing on image information to form image information for exposure, and transmits it to exposure processing section 4. Then, the control section 7 makes a photosensitive material to be exposed to image in the exposure processing section 4, and conveys this photosensitive material to print making section 5 wherein the photosensitive material is developed and dried to become prints P1, P2 and P3. The print P1 in this case is in a service size, an HDTV size or a panoramic size, the print P2 is in an A4 size and the print P3 is in a visiting card size.

Incidentally, the print size is not limited to print Pi, print P2 and print P3, and it may also be in other sizes.

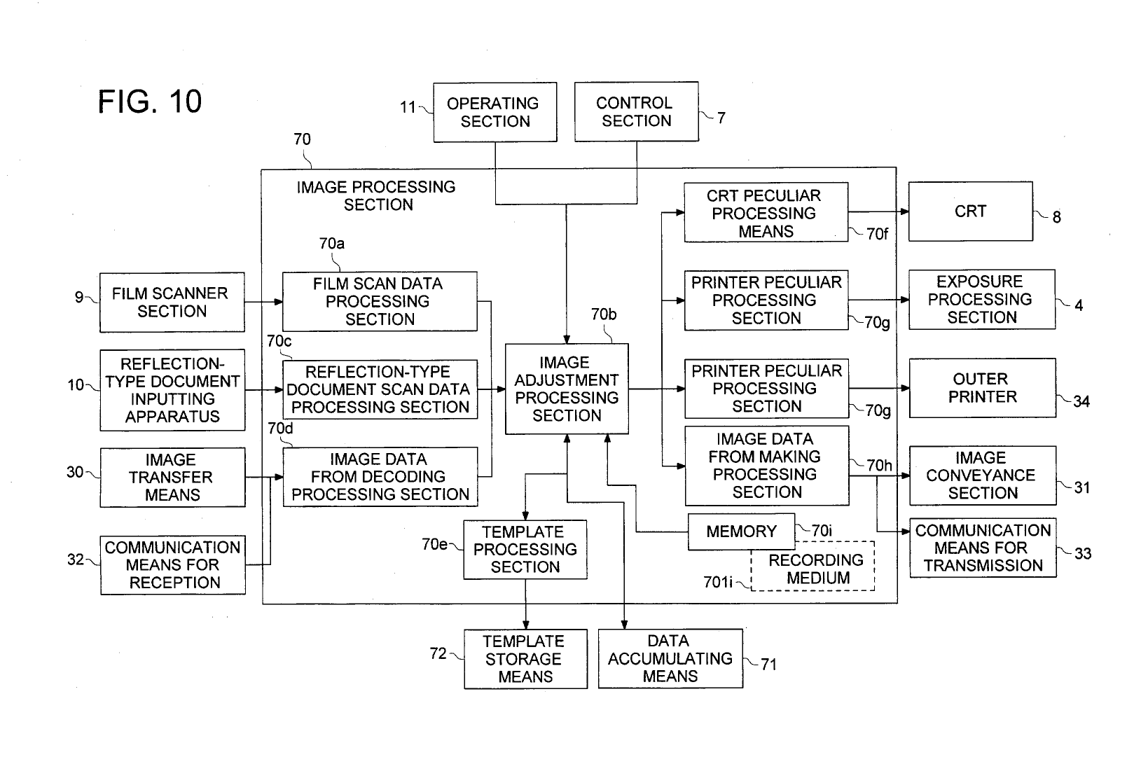

Further, the image processing section 70 receives directly image signals indicating a photographed image and work instructions for print, from a remote computer connected with another computer in the facilities or with the Internet, by using communication means 32 for receiving (see FIG. 10), and conducts image processing and make prints through remote control.

Further, it is also possible for the image processing section 70 to send the image information after image processing and its accompanying order information to a remote computer connected to another computer in the same facility or to the Internet, by the use of communication means 33 for transmission (see FIG. 10).

Image reading section 14 has a function to read frame image information obtained through photographing by digital camera Q2 and stored in PC card 13a or FD 13b and to transmit. Namely, the image reading section 14 is equipped with adaptor 14a for PC card and adaptor 14b for FD as image transfer means 30, and reads frame image information recorded in PC card 13a mounted on adaptor 14a for PC card or on Floppy (registered trademark) disk 13b mounted on adaptor 14b for FD, to transmit it to the control section 7. In this case, the adaptor 14a for PC card is, for example, a PC card reader or a PC card slot.

Incidentally, though sample identifying information D1, D2 and D3 which specify print samples can be inputted from operation section 11, it is also possible to read the aforesaid print samples or sample identifying information D1, D2 and D3 by the use of a reading means such as OCR. In addition, an operator can input sample identifying information D1, D2 and D3 from a key board.

As stated above, sample image data are recorded corresponding to sample identifying information Dl that specifies a sample of a print, the sample identifying information Dl that specifies a sample of a print is inputted, sample image data are selected based on the sample identifying information Dl to be inputted, then, the selected sample image data and image data and/or character data based on the order are compounded, and a print based on the specified sample is made, which makes a user to place an order for prints after holding various life-sized samples actually, and can cope with various demands by clients in a wide range.

Further, first sample identifying information D2 that specifies a first sample and image data for the first sample are stored, and second sample identifying information D3 that specifies a second sample and image data for the second sample are stored, then, the sample image data selected based on the specified first and second sample identifying information D2 and D3 and image data and/or character data based on the order are compounded, and a print based on the specified sample image data is made, which makes it possible to compound various types of images and to make prints meeting various demands by clients in a wider range.

Image writing section 15 is provided with adaptor 15a for FD, adaptor 15b for MO and adaptor 15c for an optical disk, and image information is recorded on each of FD 16a, MO 16b and optical disk 16c which are mounted respectively on adaptor 15a for FD, adaptor 15b for MO and adaptor 15c for an optical disk.

The image recording apparatus 1 has therein an image inputting means that takes in image information obtained by conducting divided metering for images of various digital media and image document, an image processing means that conducts processing on image information of an input image taken in by an image input means so that an image which makes a favorable impression may be given when observing the image on an output medium by acquiring or estimating information of “a size of output image” and “a size of a main photographed-subject in output image”, an image outputting means that displays a processed image, or outputs it as a print, or writes it in an image recording medium and a transmitting means that transmits image signals and accompanying order information to a remote computer connected to another computer in the facility or to the Internet through communication lines.

The image inputting means is composed of image reading section 14 that takes in image information recorded on various digital media such as PC card 13a and FD 13b, film scanner section 9 that takes in image information obtained by conducting divided metering on an image document, reflection-type document inputting apparatus 10, and communication means 32 for receiving (see FIG. 10), while, the image processing means that conducts processing on image information of an input image taken in by an image input means so that an image which makes a favorable impression may be given when observing the image on an output medium by acquiring or estimating information of “a size of output image” and “a size of a main photographed-subject in output image” is provided with image processing section 70, and the image outputting means is composed of CRT 8 that displays images, exposure processing section 4 that outputs prints and print making section 5, image writing section 15 that writes on an image recording medium and communication means 33 for transmission (see FIG. 10).

FIG. 10 is a diagram showing the schematic structure of the image processing section 70., Image signals inputted from the film scanner section 9 are subjected to proofing operation that is peculiar to the film scanner section 9, negative-positive reversing in the case of a negative document, removing of dust and scratches, gray balance adjustment, contrast adjustment, granulated noise elimination and sharpness enhancement, in film scan data processing section 70a, and are sent to image adjustment processing section 70b. Further, information about a film size, a type of negative or positive and a main photographed-subject recorded on a film optically or magnetically and information about photographing conditions (for example, contents of described information of APS) are sent to the image adjustment processing section 70b together.

Image signals inputted from the reflection-type document inputting apparatus 10 are subjected to proofing operation that is peculiar to the reflection-type document inputting apparatus 10, negative-positive reversing in the case of a negative document, removing of dust and scratches, gray balance adjustment, contrast adjustment, noise elimination and sharpness enhancement, in the reflection-type document inputting apparatus 10, and are sent to image adjustment processing section 70b.

Image signals inputted from image transfer means 30 and communication means 32 for receiving are subjected to decompression of a compression code and to conversion of an expression method for color signals as occasion demands in accordance with a data form of the image signals, in image data form decoding processing section 70d, and are converted into a data form which is suitable for operation in image processing section 70, to be sent to the image adjustment processing section 70b. Further, header information of image signals, information about a main photographed-subject obtained from tag information and information about photographing conditions are sent to the image adjustment processing section 70b together.

In addition to the foregoing, it is also possible to send information about a main photographed-subject coming from the film scanner section 9, the reflection-type document inputting apparatus 10, the image transfer means 30 and the communication means 32 for receiving and information about photographing conditions to the image adjustment processing section 70b from operation section 11.

Though the specifications about sizes of output images are inputted from operation section 11, when there are given specifications other than those stated above such as specifications about sizes of output images transmitted to communication means 32 for receiving and specifications about sizes of output images embedded in header information of image signals obtained by image transfer means 30 and in tag information, image data form decoding processing section 70d detects these information and transfers them to image adjustment processing section 70b.

When template processing is needed, the image adjustment processing section 70b transfers image signals to template processing section 70e, and receives again the image signals after the template processing. Further, the image adjustment processing section 70b conducts image processing so that an image that makes favorable impressions may be given, when images are observed on an output medium in a way described later for image signals received from film scanner section 9, reflection-type document inputting apparatus 10, image transfer means 30, communication means 32 for receiving and template processing section 70e, based on instructions of operation section 11 or of control section 7, and transmits processed image signals to CRT peculiar processing section 70f, printer peculiar processing section 70g, image data form making processing section 70h and data accumulating means 71.

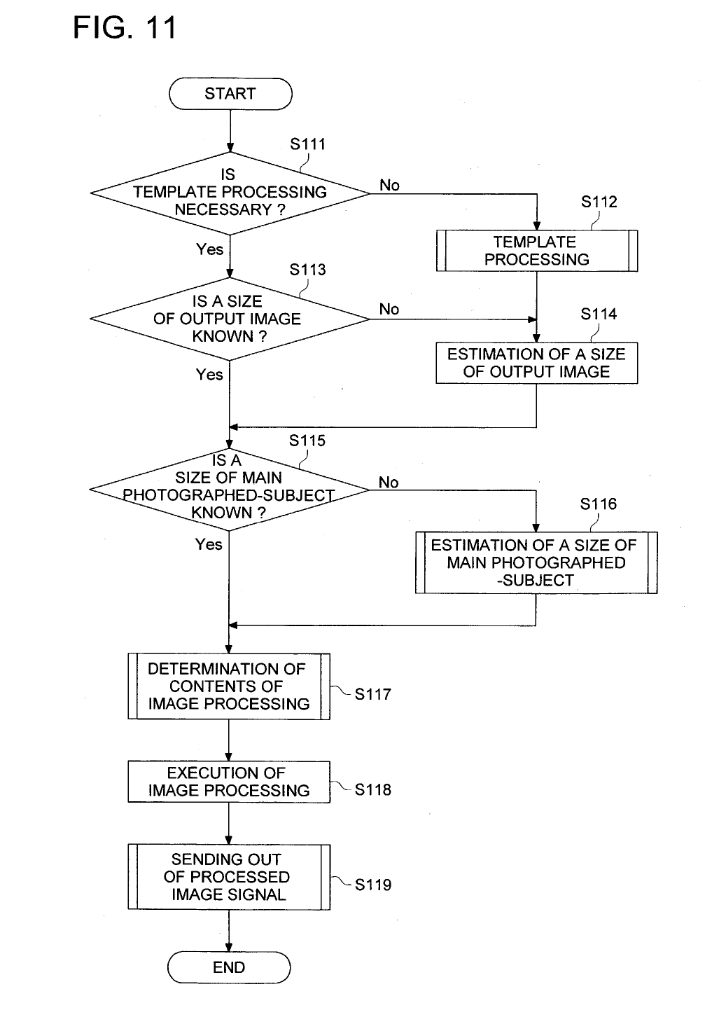

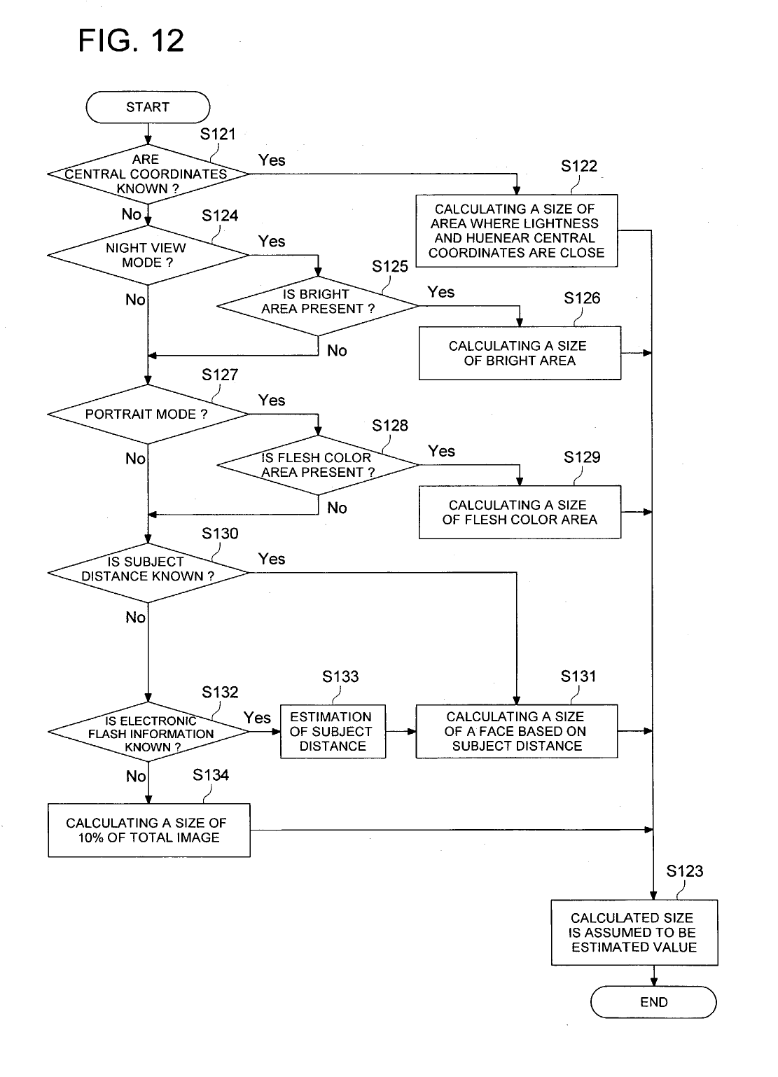

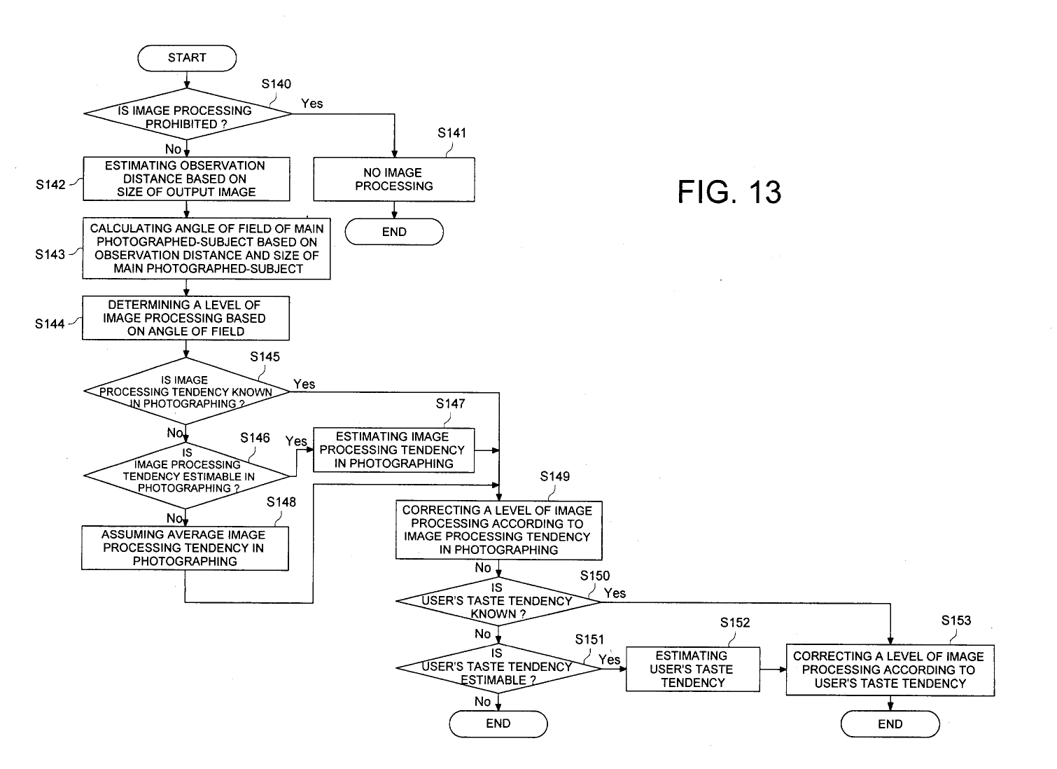

The image adjustment processing section 70b further conducts image adjustment processing shown in FIG. 11, processing to estimate a size of a main photographed-subject in photographed image shown in FIG. 12 and processing to determine contents of image processing shown in FIG. 13. The image adjustment processing section 70b conducts the processing of all sorts stated above based on image adjustment processing program (contents of the flow chart shown in FIG. 11) stored beforehand in memory 70i in image processing section 70 or in recording medium 701i provided detachably, a program for processing of estimation of a size of a main photographed-subject (contents of the flow chart shown in FIG. 12), and a program for processing of determination of contents of image processing (contents of the flow chart shown in FIG. 13).

CRT peculiar processing section 70f conducts processing such as a change in the number of pixels and color matching for image signals received from image adjustment processing section 70b, as occasion demands, and transmits to CRT 8 the signals for display wherein information that needs display such as control information is compounded.

Printer peculiar processing section 70g conducts printer peculiar proofing processing, color matching and a change in the number of pixels, as occasion demands, and transmits image signals to exposure processing section 4. When connecting outside printer 34 such as a large-size ink jet printer to image recording apparatus 1 further, printer peculiar processing section 70g is provided on each outside printer 34 to conduct appropriate printer peculiar proofing processing, color matching and a change in the number of pixels.

Image data form making processing section 70h conducts conversion to various all-purpose image formats represented by JPEG, TIFF and Exif for image signals received from image adjustment processing section 70b, as occasion demands, and transfers image signals to image conveyance section 31 or communication means for transmission 33.

The aforesaid division including film scan data processing section 70a, reflection-type document scan data processing section 70c, image data form decoding processing section 70d, image adjustment processing section 70b, image adjustment processing section 70b, CRT peculiar processing section 70f, printer peculiar processing section 70g, and image data form making processing section 70h is a division provided to help understanding of functions of image processing section of the present embodiment. Each of them does not always need to be realized as a device which is independent physically, and it may also be realized as a division of software processing types in, for example, an individual CPU.

Next, operations of image recording apparatus 1 will be explained as follows, referring to FIGS. 11, 12 and 13. FIG. 11 is a flow chart illustrating image adjustment processing by image adjustment processing section 70b.

First, the image adjustment processing section 70b judges whether template processing is necessary or not (step S 111), and when the template processing is necessary (step S 111; Yes), the image adjustment processing section 70b entrusts template processing section 70e with processing (step S 112), and then, receives image signals after processing and advances to step S 114 described later.

In the stage of step S 111, when template processing is not necessary (step S 111; No), the image adjustment processing section 70b judges whether a size of output image has already been acquired or not (step S 113), and when the size of output image is unknown (step S 113; No) or after processing of step S 112, there is conducted processing to estimate a size of output image (step S 114).

In the case of step S 114, the image adjustment processing section 70b estimates a size of output image by assuming printing conditions of general color images (for example, 300 DPI) and thereby converting the number of pixels of the image into a size of output image. When template processing of step S 112 has been conducted, the image adjustment processing section 70b is sure to check because there is a possibility that all images expressed by inputted image signals are covered by a part of output images, and converts a size of output image into a size of an image area on output images where inputted image signals appear actually.

When a size of output image at the stage of step S 113 is known (step S 113; Yes) or after processing of step S 114, the image adjustment processing section 70b judges whether a size of a main photographed-subject in output image is already acquired or not (step S 115), and when the size is unknown (step S 115; No), the image adjustment processing section 70b conducts processing to estimate a size of a main photographed-subject in output images described later (step S 116).

When a size of a main photographed-subject in output image at the stage of step S 115 is known (step S 115 Yes) or after processing of step S 116, the image adjustment processing section 70b determines contents of image processing by the method described later based on a size of output image and a size of a main photographed-subject in the output image (step S 117), and applies the determined contents of image processing to the inputted image signals (step S 118). In this case, with respect to image signals where template processing has been conducted in step S 112, the image adjustment processing section 70b makes only a portion corresponding to image signals indicating inputted photographed image among image signals to be a target, and then, transmits the image signals which have been subjected to image processing to the outside.

Next, processing to estimate a size of a main photographed-subject in step S 116 shown in FIG. 11 will be explained in detail. FIG. 12 is a flow chart showing the processing to estimate a size of a main photographed-subject.

First, the image adjustment processing section 70b judges whether central coordinates of the main photographed-subject have been acquired or not (step S 121), and when they have been acquired (step S 121; Yes), the image adjustment processing section 70b calculates average hue and average lightness of several pixels in the periphery of the specified coordinates (step S 122), and estimates a size of a pixel area wherein hue and lightness are within a certain range (for example, a difference between hue angles is within 100, and a difference of lightness is within 10% of a dynamic range) from the average value in the periphery of the specified central coordinates (step S 123).

When central coordinates of a main photographed-subject is not acquired in the stage of step S 121 (step S 121; No), image adjustment processing section 70b judges whether the image is in a night view mode or not (step S 124).

When the image is in a night view mode in the stage of step 124 (step S 124; Yes), the image adjustment processing section 70b further judges whether there is present an area that is partially bright or not (step S 124; Yes), and when there is present an area that is partially bright (step S 124; Yes), the image adjustment processing section 70b calculates a size of that area (step S 126). When a plurality of bright areas are present in this case, a size of the largest area or a size of the area closest to the center of the image is used.

When there is no bright area in the stage of step S 125 (step S 125; No), or when the night view mode is not found in the stage of step S 124 (step S 124; No), the image adjustment processing section 70b judges whether the image is in a portrait mode or not (step S 127).

When the image is in a portrait mode in the stage of step S 127 (step S 127; Yes), the image adjustment processing section 70b further judges whether a flesh color area with an appropriate size (for example, diameter is ⅕ or more of a length of a shorter side of a pixel) exists at a relatively central portion of the image or not (step S 128), and when the flesh color area is present (step S 128; Yes), the image adjustment processing section 70b calculates a size of the flesh color area (step S 129).

When no flesh color area is present in the stage of step S 128 (step S 128; No) or when the image is not in a portrait mode in step S 127 (step S 127; No), the image adjustment processing section 70b judges whether a subject distance is acquired or not (step S 130), and when the subject distance is known (step S 130; Yes), the image adjustment processing section 70b calculates a size of a face corresponding to lens characteristics of a general compact camera and a subject distance, assuming that a main photographed-subject is a face of a person (step S 131).

When the subject distance is unknown in the stage of step S 130 (step S 130; No), the image adjustment processing section 70b judges whether information about strobe has been acquired or not (step S 132), and when the information about strobe is known (step S 132; Yes), the image adjustment processing section 70b estimates the subject distance from return detection and a guide number (step S 133), and calculates a size of a face corresponding to the subject distance in step S 131.

When strobe information has not been acquired in the stage of step S 132 (step S 132; No), the image adjustment processing section 70b calculates 10% of a size of the total image (step S 134).

The image adjustment processing section 70b employs a value calculated in either step of steps S 122, S 126, S 129, S 131 and S 134 as an estimated value of a main photographed-subject (step S 123).

Incidentally, the embodiment given here is an example, and the invention is not limited to the aforementioned methods of judgment. It is preferable that estimation is tried in succession from the method having higher probability of estimation accuracy, by judging the tendency of characteristics of image signals inputted in the environment in which the apparatus of the invention operates.

Next, processing to determine contents of image processing in step S 117 shown in FIG. 11 will be explained in detail. FIG. 13 is a flow chart illustrating processing of determining contents of image processing.

There is a possibility that image signals which have already been image-processed based on consideration to give images making favorable impression when images are observed on an output medium, and image signals wherein image processing in the course of output is prohibited based on specific intention are intermingled in the image signals indicating a photographed image. With respect to these image signals, it is preferable that information to the effect of prohibiting image processing in the course of outputting is recorded beforehand in header information and tag information in various types of all-purpose image format represented by JPEG, TIFF and Exif, or an operator gives an instruction to prohibit image processing through operation section 11.

Therefore, the image adjustment processing section 70b judges whether image processing is prohibited or not by referring to the header information, tag information and the instruction from the operation section 11, before processing to determine contents of image processing (step S 140). When image processing is prohibited (step S 140; Yes), the image adjustment processing section 70b determines the contents of image processing to be “no image processing”, and does not conduct image processing (step S 141).

When image processing is not prohibited in the stage of step S 140 (step S 140; No), the image adjustment processing section 70b calculates (estimates) an observation distance from the relationship shown in FIG. 1 based on the size of output image (step S 142).

Next, the image adjustment processing section 70b calculates an angle of field of a main photographed-subject in the course of observation by the use of, for example, the following expression, based on the aforesaid observation distance and a size of the main photographed-subject (step S 143);

Numeral 2

$$φ = 2 \cdot {tan}^{- 1} ( \frac{d}{r} ) \qquad Numeral 2$$

wherein, θ represents an angle of field, d represents a radius of a main photographed-subject and r represents an observation distance.

Then, the image adjustment processing section 70b determines levels of image processing such as contrast setting, sharpness enhancement degree, control of granulated noise and a degree of enhancement of chroma, from relationships shown in FIGS. 2-5, based on the angle of field calculated in step S 143 (step S 144).

Next, the image adjustment processing section 70b checks whether information about tendency of image processing in the course of photographing has been acquired or not (step S 145), and when that information is not acquired (step S 145; No), the image adjustment processing section 70b checks whether information that can be used to estimate the image processing tendency in the course of photographing has been acquired or not (step S 146). As the information that can be used to estimate the image processing tendency in the course of photographing, there are given a digital camera model and a maker name, and it is possible to estimate image processing tendency in the course of photographing by referring table data in which the image processing tendencies for a model and a maker are recorded in advance.

When the information that can be used to estimate the image processing tendency in the course of photographing is not acquired in the stage of step S 146 (step S 146; No), the image adjustment processing section 70b assumes that average image processing tendencies for each model and each maker have been given in the course of photographing (step S 148), and proceeds to step S 149.

When the image processing tendency in the course of photographing is known in the stage of step S 145 (step S 145; Yes), when it is possible to estimate image processing tendency in the course of photographing in the stage of step S 146 and when the image processing tendency is estimated (step S 146; Yes, step S 147), or after step S 148, the image adjustment processing section 70b corrects contents of image processing based on the image processing tendency in the course of photographing (step S 149).

For example, it is possible to put image characteristics of output images within an appropriate range by correcting the degree of image processing in the invention in a way to consider overlapping with image processing in the course of photographing and inversion, which is exemplified as follows; when contrast is established to be high already in the course of photographing, contrast enhancement in the case where a size of a main photographed-subject on an image is smaller than a range of angle of field 100 is controlled or abolished, and the degree of contrast reduction in the case where a size of a main photographed-subject on an image is larger than a range of angle of field 10° is enhanced. Incidentally, when image signals indicating a photographed image have been generated by a film scanner or a flat bed scanner (both of them are not shown), it is preferable to conduct the same correction as in the foregoing by acquiring or estimating information relating to a tendency of image processing in the course of scan image generation.

After step S 149, the image adjustment processing section 70b judges whether information about a tendency of user taste has been acquired or not (step S 150), and corrects the level of image processing in accordance with the acquired tendency of user taste, when the information about a tendency of user taste has been acquired (step S150; Yes).

When information about a tendency of user taste has not been acquired in the stage of step S 150 (step S 150; No), the image adjustment processing section 70b judges whether information that can be used for estimating a tendency of user taste has been acquired or not (step S 151).

When the information that can be used for estimating a tendency of user taste has been acquired in the stage of step S 151 (step S 151; Yes), the image adjustment processing section 70b estimates a tendency of user taste based on that information (step S 152).

When a tendency of user taste is known (step S 150; Yes) or a tendency of user taste is estimated (step S 152), the image adjustment processing section 70b corrects contents of image processing based on the tendency of user taste acquired or estimated (step S 153). Owing to the above procedures, contents of image processing conducted based on a size of the output images and a size of a main photographed-subject in output images are decided.

Incidentally, procedures to determine the contents of image processing shown in FIG. 13 represent an example, and the invention is not limited to the aforementioned steps S 140-S 153.

A description in the embodiment of the invention shows concrete examples of the image processing method and the programs to execute the image processing method, the image processing apparatus and the image recording apparatus, and the invention is not limited to them. Detailed structures and detailed operations of image recording apparatus 1 in the present embodiment may be changed appropriately within a range that does not deviate from the main points and spirit of the invention.

Technologies of the invention make it possible to realize an image processing method, an image processing apparatus and an image recording apparatus which give an image that makes favorable impression when observing the image on an output medium, in a simple and all-purpose method, without doing highly loaded calculation, only by acquiring or estimating clear information such as “a size of output image” and “a size of a main photographed-subject in output images”. It is further possible to obtain stable effects by acquiring an image processing tendency in the course of photographing and by acquiring or estimating a tendency of user taste. Further, by acquiring information needed by the invention from the so-called tag information added to image signals indicating a photographed image, or by estimating information needed by the invention from the tag information, it is possible to realize an image processing method, an image processing apparatus and an image recording apparatus which can conform to complicated environment wherein image signals indicating a photographed image generating by various photographing apparatuses are intermingled and are received through media and communication means.

What is claimed is:

1. A method of applying an image processing onto two dimensionally-arranged image data representing a photographed image including a main photographed-subject and producing image signals to reproduce the photographed image visually with one of various reproduction sizes on one of various kinds of recording media, comprising:
a reproduction size determining step of determining a reproduction size of the photographed image to be reproduced visually on a recording medium;
a subject size determining step of determining a size of the main photographed-subject on the determined reproduction size of the photographed image;
an image processing content changing step of changing a content of the image processing on the basis of the determined reproduction size of the photographed image and the determined size of the main photographed-subject; and
a processing step of applying the image processing with the changed content onto the two dimensionally-arranged image data and producing image signals to reproduce the photographed image visually with the determined reproduction size on the recording medium.

2. The method of claim 1, wherein the image processing content changing step estimates an angle of field for the main photographed-subject from a viewing distance to observe the photographed image reproduced with the determined reproduction size and changes the content of the image processing on the basis of the estimated angle of field for the main photographed-subject.

3. The method of claim 1, wherein the reproduction size determining step determines the size of the main photographed-subject on a basis of the determined reproduction size of the photographed image.

4. The method of claim 1, wherein the subject size determining step obtains an occupying ratio of the main photographed-subject on the photographed image and determines the size of the main photographed-subject on the basis of the obtained occupying ratio.

5. The method of claim 4, wherein the two dimensionally-arranged image data are provided with additional data including size information and the subject size determining step obtains the occupying ratio from the size information of the additional data.

6. The method of claim 1, wherein the two dimensionally-arranged image data are provided with additional data including photographing information and the subject size determining step estimates an occupying ratio of the main photographed-subject on the photographed image from the photographing information of the additional data and determines the size of the main photographed-subject on the basis of the estimated occupying ratio.

7. The method of claim 6, wherein the photographing information includes at least one of a subject area, a type of a photographed scene, a subject distance and a detection of reflected strobe light.

8. The method of claim 6, wherein the subject size determining step estimates an occupying ratio of the main photographed-subject on the photographed image from the two dimensionally-arranged image data and determines the size of the main photographed-subject on the basis of the estimated occupying ratio.

9. The method of claim 1, further comprising:
a processing tendency obtaining step of obtaining a tendency of the image processing applied when the image signals representing the photographed image are produced; and
a correcting step of correcting an extent of the image processing on the basis of the tendency of the image processing obtained by the processing tendency obtaining step.

10. The method of claim 9, wherein the tendency of the image processing obtained by the processing tendency obtaining step includes at least one of a contrast processing, a sharpness processing, a granularity processing, and a chroma processing which is applied when the image signals representing the photographed image are produced.

11. The method of claim 10, wherein the correcting step corrects the extent of the image processing with the consideration for duplication or reciprocity for the image processing applied when the image signals representing the photographed image are produced.

12. The method of claim 10, wherein the two dimensionally-arranged image data are provided with additional data and the processing tendency obtaining step obtains the tendency of the image processing from the additional data.

13. The method of claim 1, further comprising:
a preference tendency obtaining step of obtaining a preference tendency of a user; and
a correcting step of correcting an extent of the image processing on the basis of the preference tendency of the user obtained by the processing tendency obtaining step.

14. The method of claim 13, wherein the preference tendency obtaining step obtains information regarding at least one of a type of a photographing device, a number of photographing pixels, an exposing mode and a white balance and obtains the preference tendency of the user from the obtained information.

15. The method of claim 13, wherein the two dimensionally-arranged image data are provided with additional data and the preference tendency obtaining step obtains the preference tendency of the user from the additional data.

16. The method of claim 2, wherein the image processing content changing step changes the content of the image processing in accordance with whether or not the angle of field is 10° or less.

17. The method of claim 16, wherein when the angle of field is smaller, the image processing content changing step increases the contrast more.

18. The method of claim 17, wherein when the angle of field is smaller than 10°, the image processing content changing step increases the contrast by 5% or more.

19. The method of claim 16, wherein when the angle of field is larger, the image processing content changing step decreases the contrast less.

20. The method of claim 19, wherein when the angle of field is larger than 10°, the image processing content changing step decreases the contrast by 5% or less.

21. The method of claim 16, wherein when the angle of field is smaller than 10°, the smaller the angle of field is, the more an edge enhancement processing or a high frequency component enhancement processing is applied.

22. The method of claim 16, wherein when the angle of field is larger than 10°, the larger the angle of field is, the more a granular noise eliminating processing or an intermediate frequency component reflecting processing is applied.

23. The method of claim 16, wherein when the angle of field is smaller than 10°, the smaller the angle of field is, the more a chroma enhancement processing or a high frequency component enhancement processing is applied.

24. The method of claim 16, wherein when the angle of field is larger than 10°, the larger the angle of field is, the more a chroma enhancement processing or a high frequency component enhancement processing is applied.

25. A readable product from which a program representing an image processing method is read, the image processing method is a method of applying an image processing onto two dimensionally-arranged image data representing a photographed image including a main photographed-subject and producing image signals to reproduce the photographed image visually with one of various reproduction sizes on one of various kinds of recording media, comprising:
a reproduction size determining step of determining a reproduction size of the photographed image to be reproduced visually on a recording medium;
a subject size determining step of determining a size of the main photographed-subject on the determined reproduction size of the photographed image;
an image processing content changing step of changing a content of the image processing on the basis of the determined reproduction size of the photographed image and the determined size of the main photographed-subject; and
a processing step of applying the image processing with the changed content onto the two dimensionally-arranged image data and producing image signals to reproduce the photographed image visually with the determined reproduction size on the recording medium.

26. The readable product of claim 25, wherein the image processing content changing step estimates an angle of field for the main photographed-subject from a viewing distance to observe the photographed image reproduced with the determined reproduction size and changes the content of the image processing on the basis of the estimated angle of field for the main photographed-subject.

27. The readable product of claim 25, wherein the two dimensionally-arranged image data are provided with additional data including size information and the subject size determining step obtains the occupying ratio from the size information of the additional data.

28. The readable product of claim 25, wherein the two dimensionally-arranged image data are provided with additional data including photographing information and the subject size determining step estimates an occupying ratio of the main photographed-subject on the photographed image from the photographing information of the additional data and determines the size of the main photographed-subject on the basis of the estimated occupying ratio.

29. The readable product of claim 25, wherein the subject size determining step estimates an occupying ratio of the main photographed-subject on the photographed image from the two dimensionally-arranged image data and determines the size of the main photographed-subject on the basis of the estimated occupying ratio.

30. The readable product of claim 25, further comprising:
a processing tendency obtaining step of obtaining a tendency of the image processing applied when the image signals representing the photographed image are produced; and
a correcting step of correcting an extent of the image processing on the basis of the tendency of the image processing obtained by the processing tendency obtaining step.

31. The readable product of claim 25, further comprising:
a preference tendency obtaining step of obtaining a preference tendency of a user; and
a correcting step of correcting an extent of the image processing on the basis of the preference tendency of the user obtained by the processing tendency obtaining step.

32. An apparatus for applying an image processing onto two dimensionally-arranged image data representing a photographed image including a main photographed-subject and producing image signals to reproduce the photographed image visually with one of various reproduction sizes on one of various kinds of recording media, comprising:
a reproduction size determining section for determining a reproduction size of the photographed image to be reproduced visually on a recording medium;
a subject size determining section for determining a size of the main photographed-subject on the determined reproduction size of the photographed image;
an image processing content changing section for changing a content of the image processing on the basis of the determined reproduction size of the photographed image and the determined size of the main photographed-subject; and
a processing section for applying the image processing with the changed content onto the two dimensionally-arranged image data and producing image signals to reproduce the photographed image visually with the determined reproduction size on the recording medium.

33. The apparatus of claim 32, wherein the subject size determining section obtains an occupying ratio of the main photographed-subject on the photographed image and determines the size of the main photographed-subject on the basis of the obtained occupying ratio.

34. The apparatus of claim 33, wherein the two dimensionally-arranged image data are provided with additional data including size information and the subject size determining section obtains the occupying ratio from the size information of the additional data.

35. The apparatus of claim 33, wherein the two dimensionally-arranged image data are provided with additional data including photographing information and the subject size determining section estimates an occupying ratio of the main photographed-subject on the photographed image from the photographing information of the additional data and determines the size of the main photographed-subject on the basis of the estimated occupying ratio.

36. The apparatus of claim 32, further comprising:
a processing tendency obtaining section for obtaining a tendency of the image processing applied when the image signals representing the photographed image are produced; and
a correcting section for correcting an extent of the image processing on the basis of the tendency of the image processing obtained by the processing tendency obtaining section.

37. The apparatus of the claim 32, further comprising:
a preference tendency obtaining section for obtaining a preference tendency of a user; and
a correcting section for correcting an extent of the image processing on the basis of the preference tendency of the user obtained by the processing tendency obtaining step.
